(19) United States
(12) Patent Application Publication
(10) Pub. No.: US 2026/0287858 A1
(43) Pub. Date: Sep. 24, 2026

(54) OPTICAL IMAGING SYSTEM

(71) Applicant: SAMSUNG ELECTRO-MECHANICS CO., LTD., Suwon-si (KR)

(72) Inventors: Kum Ho KIM, Suwon-si (KR); Ji Su LEE, Suwon-si (KR); Duck Hun KIM, Suwon-si (KR); Chang Min LEE, Suwon-si (KR); Ji Soo YOO, Suwon-si (KR)

(73) Assignee: SAMSUNG ELECTRO-MECHANICS CO., LTD., Suwon-si (KR)

(21) Appl. No.: 19/553,912

(22) Filed: Mar. 2, 2026

(30) Foreign Application Priority Data
Mar. 18, 2025 (KR) 10-2025-0034846
Sep. 18, 2025 (KR) 10-2025-0134561

(51) Int. Cl. G02B 13/00; G02B 9/64

(52) U.S. Cl. CPC G02B 13/0045; G02B 9/64

(57) ABSTRACT

An optical imaging system includes a first lens having positive refractive power, a second lens having negative refractive power, a third lens having refractive power, a fourth lens having refractive power, a fifth lens having refractive power, a sixth lens having positive refractive power, and a seventh lens having negative refractive power, disposed in order from an object side, wherein 0.9<1.2×f/(2×IMG HT)<1.1 is satisfied, where f is a total focal length of the first lens to the seventh lens, and IMG HT is half a diagonal length of an imaging plane.

### CROSS-REFERENCE TO RELATED APPLICATIONS

This application claims the benefit under 35 USC 119(a) of Korean Patent Application No. 10-2025-0034846 filed on Mar. 18, 2025, in the Korean Intellectual Property Office and Korean Patent Application No. 10-2025-0134561 filed on Sep. 18, 2025, in the Korean Intellectual Property Office, the entire disclosures of which are incorporated herein by reference for all purposes.

### BACKGROUND

### 1. Field

The present disclosure relates to an optical imaging system.

### 2. Description of the Background

Mobile devices may include cameras including an optical imaging system comprising a plurality of lenses for video calls and photos.

Also, as the functionality of cameras in a mobile device has increased, demand for high-resolution mobile device cameras has grown.

As mobile devices have been designed to have a reduced size, demand for slimmer mobile device cameras has also increased. Accordingly, it may be an objective to develop an optical imaging system having a reduced size and implementing high resolution.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having positive refractive power, a second lens having negative refractive power, a third lens having refractive power, a fourth lens having refractive power, a fifth lens having refractive power, a sixth lens having positive refractive power, and a seventh lens having negative refractive power, disposed in order from an object side, wherein 0.9<1.2×f/(2×IMG HT)<1.1 is satisfied, where f is a total focal length of the first lens to the seventh lens, and IMG HT is half a diagonal length of an imaging plane.

3 [°/mm]<FOV/(2×IMG HT)<6 [°/mm] may be satisfied, where FOV is a field of view of the optical imaging system including the first lens to the seventh lens.

4 [°/mm]<FOV/f<6.5 [°/mm] may be satisfied, where FOV is a field of view of the optical imaging system including the first lens to the seventh lens.

0.25<T13/TTL<0.4 may be satisfied, where T13 is a distance on an optical axis from an object-side surface of the first lens to an object-side surface of the third lens, and TTL is a distance on the optical axis from an object-side surface of the first lens to the imaging plane.

1.0<SD1/SD5<1.5 may be satisfied, where SD1 is an effective radius of an object-side surface of the first lens, and SD5 is an effective radius of an object-side surface of the third lens.

0.4<SD6/SD14<0.7 may be satisfied, where SD6 is an effective radius of an image-side surface of the third lens, and SD14 is an effective radius of an image-side surface of the seventh lens.

The second lens may have a refractive index greater than 1.65, and 30<v1−v2<40 may be satisfied, where v1 is an Abbe number of the first lens and v2 is an Abbe number of the second lens.

Each of the first lens and the fifth lens may have a refractive index less than 1.6, and the refractive index of the first lens may be less than the refractive index of the fifth lens, and 10<v1−v5<20 may be satisfied, where v1 is an Abbe number of the first lens and v5 is an Abbe number of the fifth lens.

Each of the first lens and the seventh lens may have a refractive index less than 1.6, and the refractive index of the seventh lens may be less than the refractive index of the first lens, and 0<v1−v7<1 may be satisfied, where v1 is an Abbe number of the first lens, and v7 is an Abbe number of the seventh lens.

(TTL/(2×IMG HT))×Fno<1.65 may be satisfied, where TTL is a distance on the optical axis from an object-side surface of the first lens to the imaging plane, and Fno is an F-number of the optical imaging system including the first lens to the seventh lens. 0.85<TTL/(2×IMG HT))<1.00 may be satisfied.

0.7<f1/f<1.1 may be satisfied, where f1 is a focal length of the first lens.

0.5<f1/f12<0.9 may be satisfied, where f1 is a focal length of the first lens, and f12 is a combined focal length of the first lens and the second lens.

0<f12/|f34567|<0.2 may be satisfied, where f12 is a combined focal length of the first lens and the second lens, and f34567 is a combined focal length of the third lens to the seventh lens.

The third lens may have negative refractive power, and each of the second and third lenses may have a refractive index greater than 1.65.

The first lens may have a convex object-side surface and a concave image-side surface, the second lens may have a convex object-side surface and a concave image-side surface, and the fifth lens may have a convex object-side surface and a concave image-side surface.

Other features and aspects will be apparent from the following detailed description, the drawings, and the claims.

### BRIEF DESCRIPTION OF DRAWINGS

FIG. 1 is a configuration diagram illustrating an optical imaging system according to a first embodiment.

FIG. 2 is a graph indicating aberration properties of the optical imaging system illustrated in FIG. 1.

FIG. 3 is a configuration diagram illustrating an optical imaging system according to a second embodiment.

FIG. 4 is a graph indicating aberration properties of the optical imaging system illustrated in FIG. 3.

FIG. 5 is a configuration diagram illustrating an optical imaging system according to a third embodiment.

FIG. 6 is a graph indicating aberration properties of the optical imaging system illustrated in FIG. 5.

FIG. 7 is a configuration diagram illustrating an optical imaging system according to a fourth embodiment.

FIG. 8 is a graph indicating aberration properties of the optical imaging system illustrated in FIG. 7.

FIG. 9 is a configuration diagram illustrating an optical imaging system according to a fifth embodiment.

FIG. 10 is a graph indicating aberration properties of the optical imaging system illustrated in FIG. 9.

FIG. 11 is a configuration diagram illustrating an optical imaging system according to a sixth embodiment.

FIG. 12 is a graph indicating aberration properties of the optical imaging system illustrated in FIG. 11.

FIG. 13 is a configuration diagram illustrating an optical imaging system according to a seventh embodiment.

FIG. 14 is a graph indicating aberration properties of the optical imaging system illustrated in FIG. 13.

FIG. 15 is a configuration diagram illustrating an optical imaging system according to an eighth embodiment.

FIG. 16 is a graph indicating aberration properties of the optical imaging system illustrated in FIG. 15.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In the drawings, a thickness, size, and shape of a lens may be exaggerated for ease of description, and a spherical or aspherical shape of a lens is merely an example and is not limited thereto.

An aspect of the present disclosure is to provide an optical imaging system implementing high resolution.

An optical imaging system according to an embodiment may include seven lenses.

The first lens may refer to the lens closest to the object side, and the seventh lens may refer to the lens closest to the imaging plane (or image sensor).

Also, in the embodiments, numerical values for the radius, thickness, distance, and focal length of the lenses are all in millimeters, and the unit of field of view (FOV) may be degrees.

Also, in the description related to the shape of each lens, a convex surface may indicate that a paraxial region (narrow region in vicinity of an optical axis and including the optical axis) portion of a surface may be convex, and a concave surface may indicate that a paraxial region portion of the surface may be concave.

Accordingly, even when one surface of the lens is described as having a convex shape, an edge portion of the lens may be concave. Similarly, even when one surface of a lens is described as having a concave shape, an edge portion of the lens may be convex.

The term “paraxial region” may refer to a narrow region adjacent to and including the optical axis.

The imaging plane may refer to a virtual surface on which focus is formed by the optical imaging system. Alternatively, the imaging plane may refer to a surface of an image sensor on which light is received.

The optical imaging system according to an embodiment may include at least seven lenses.

For example, an optical imaging system according to an embodiment may include a first lens, a second lens, a third lens, a fourth lens, a fifth lens, a sixth lens, and a seventh lens, arranged sequentially from the object side. The first lens to the seventh lens may be spaced apart from each other by a predetermined distance along the optical axis.

An optical imaging system according to an embodiment may further include an image sensor for converting an image of an incident subject into an electrical signal.

Also, the optical imaging system may further include an infrared filter (hereinafter referred to as a “filter”) for blocking infrared rays. The filter may be disposed between the seventh lens and the image sensor.

Also, the optical imaging system may further include a stop for controlling the amount of light.

The first lens to the seventh lens included in the optical imaging system according to an embodiment may be formed of a plastic material.

Also, at least one lens among the first lens to the seventh lens may have an aspherical surface. For example, each of the first lens to the seventh lens may have at least one aspherical surface.

That is, at least one of an object-side surface and an image-side surface of each of the first lens to the seventh lens may be aspherical. Here, the aspherical surfaces of the first lens to the seventh lens may be represented by Equation 1 below.

$$Z = \frac{c {Y}^{2}}{1 + \sqrt{1 - ( 1 + K ) {c}^{2} {Y}^{2}}} + A {Y}^{4} + B {Y}^{6} + C {Y}^{8} + D {Y}^{10} + E {Y}^{12} + F {Y}^{14} + G {Y}^{16} + H {Y}^{18} + J {Y}^{20} + {LY}^{22} + M {Y}^{24} + N {Y}^{26} + {OY}^{28} + P {Y}^{30} \qquad [ Equation 1 ]$$

In Equation 1, c may be the curvature (the reciprocal of the radius of curvature) of the lens, K may be the conic constant, and Y may be the distance from an arbitrary point on an aspherical surface of the lens to the optical axis. Also, the constants A to H, J, and L to P may be aspherical coefficients. Z(SAG) may be the distance in the optical axis direction between an arbitrary point on an aspherical surface of the lens and an apex of the aspherical surface.

The optical imaging system according to an embodiment may satisfy at least one of conditional expressions as below.

In an embodiment, the optical imaging system may satisfy the condition (TTL/(2×IMG HT))×Fno<1.65, where TTL may be the distance on the optical axis from an object-side surface of the first lens to an imaging plane, IMG HT may be half the diagonal length of the imaging plane, and Fno may be the F-number of the optical imaging system. Accordingly, a bright image may be obtained and the size of the optical imaging system may be reduced.

The optical imaging system may satisfy the condition 1.53<(TTL/(2×IMG HT))×Fno<1.63. For example, the optical imaging system may satisfy the condition 1.593<(TTL/(2×IMG HT))×Fno≤1.603.

In an embodiment, the optical imaging system may satisfy the condition 3 [°/mm]<FOV/(2×IMG HT)<6 [°/mm]. Here, FOV may be the field of view of the optical imaging system. Accordingly, an appropriate field of view may be implemented while improving image quality.

The optical imaging system may satisfy the condition 4.5 [°/mm]<FOV/(2×IMG HT)<5.5 [°/mm]. For example, the optical imaging system may satisfy the condition 4.975 [°/mm]<FOV/(2×IMG HT)≤4.998 [°/mm].

In an embodiment, the optical imaging system may satisfy the condition 0.9<1.2×f/(2×IMG HT)<1.1, where f may be the total focal length of the optical imaging system. Accordingly, an appropriate field of view may be implemented while improving image quality.

The optical imaging system may satisfy the condition 0.95<1.2×f/(2×IMG HT)<0.98. For example, the optical imaging system may satisfy the condition 0.969<1.2×f/(2×IMG HT)≤0.970.

In an embodiment, the optical imaging system may satisfy the condition 0.25<T13/TTL<0.4, where T13 may be the distance on the optical axis from an object-side surface of the first lens to an object-side surface of the third lens. Accordingly, the size of the optical imaging system may be reduced while improving image quality.

The optical imaging system may satisfy the condition 0.26<T13/TTL<0.397. For example, the optical imaging system may satisfy the condition 0.265≤T13/TTL<0.392.

In an embodiment, the optical imaging system may satisfy the condition 1.0<SD1/SD5<1.5, where SD1 may be the effective radius of an object-side surface of the first lens, and SD5 may be the effective radius of an object-side surface of the third lens. Accordingly, image quality may be improved.

The optical imaging system may satisfy the condition 1.1<SD1/SD5<1.3. For example, the optical imaging system may satisfy the condition 1.156≤SD1/SD5<1.266.

In an embodiment, the optical imaging system may satisfy the condition 0.4<SD6/SD14<0.7, where SD6 may be the effective radius of an image-side surface of the third lens, and SD14 may be the effective radius of an image-side surface of the seventh lens. Accordingly, image quality may be improved.

The optical imaging system may satisfy the condition 0.5<SD6/SD14<0.6. For example, the optical imaging system may satisfy the condition 0.51≤SD6/SD14<0.544.

In an embodiment, the optical imaging system may satisfy the condition 4 [°/mm]<FOV/f<6.5 [°/mm]. Accordingly, an appropriate field of view may be implemented while improving image quality.

The optical imaging system may satisfy the condition 5.5 [°/mm]<FOV/f<6.3 [°/mm]. For example, the optical imaging system may satisfy the condition 6.156 [°/mm]≤FOV/f≤6.183 [°/mm].

In an embodiment, the optical imaging system may satisfy the condition 30<v-v2<40, where v1 may be the Abbe number of the first lens and v2 may be the Abbe number of the second lens. Accordingly, chromatic aberration may be addressed.

The optical imaging system may satisfy the condition 35<v−v2<38. For example, the optical imaging system may satisfy the condition 36.75≤v−v2≤37.66.

In an embodiment, the optical imaging system may satisfy the condition 10<v1−v5<20, where v5 may be the Abbe number of the fifth lens. Accordingly, chromatic aberration may be addressed.

The optical imaging system may satisfy the condition 16<v1−v5<19. For example, the optical imaging system may satisfy the condition 18<v1−v5≤18.59.

In an embodiment, the optical imaging system may satisfy the condition 0<v1−v7<1, where v7 may be the Abbe number of the seventh lens. Accordingly, chromatic aberration may be addressed.

The optical imaging system may satisfy the condition 0<v1−v7<0.5. For example, the optical imaging system may satisfy the condition 0.2<v1−v7≤0.25.

In an embodiment, the optical imaging system may satisfy the condition 0.7<f1/f<1.1, where f1 may be the focal length of the first lens. Accordingly, aberrations may be reduced by appropriately adjusting the refractive power of the first lens.

The optical imaging system may satisfy the condition 0.8<f1/f<0.95. For example, the optical imaging system may satisfy the condition 0.812<f1/f<0.933.

In an embodiment, the optical imaging system may satisfy the condition 0.5<f1/f12<0.9, where f12 may be the combined focal length of the first and second lenses. Accordingly, aberrations may be reduced by appropriately adjusting the refractive power of the first and second lenses.

The optical imaging system may satisfy the condition 0.6<f1/f12<0.8. For example, the optical imaging system may satisfy the condition 0.623≤f1/f12<0.720.

In an embodiment, the optical imaging system may satisfy the condition 0<f12/|f34567| <0.2. Here, f34567 may be the combined focal length of the third lens to the seventh lens. Accordingly, aberrations may be reduced by appropriately adjusting the refractive power of each lens.

The optical imaging system may satisfy the condition 0<f12/|f34567|<0.19. For example, the optical imaging system may satisfy the condition 0<f12/|f34567|≤0.179.

In an embodiment, the optical imaging system may satisfy the condition 1.5<Fno<1.9, where Fno may be the F-number of the optical imaging system. Accordingly, the image brightness may be improved.

The optical imaging system may satisfy the condition 1.6<Fno<1.8. For example, the optical imaging system may satisfy the condition 1.69≤Fno≤1.70.

In an embodiment, the optical imaging system may satisfy the condition 0.85<TTL/(2×IMG HT))<1.00. Accordingly, the size of the optical imaging system may be reduced.

The optical imaging system may satisfy the condition 0.91<TTL/(2×IMG HT))<0.97. For example, the optical imaging system may satisfy the condition 0.942<TTL/(2×IMG HT))≤0.943.

In an embodiment, the second lens may have a refractive index greater than 1.65.

In an embodiment, each of the first lens and the fifth lens may have a refractive index less than 1.6, and the refractive index of the first lens may be configured to be less than the refractive index of the fifth lens.

In an embodiment, each of the first lens and the seventh lens may have a refractive index less than 1.6, and the refractive index of the seventh lens may be configured to be less than the refractive index of the first lens.

In an embodiment, each of two lenses disposed adjacent to each other may have negative refractive power and a refractive index greater than 1.65. For example, each of the second lens and the third lens may have negative refractive power and a refractive index greater than 1.65.

In an embodiment, one of the fourth lens or the fifth lens may have the largest absolute focal length among all of the lenses.

In an embodiment, the combined focal length of the first lens and the second lens may have a positive value.

In an embodiment, the combined focal length of the third lens to the seventh lens may have a positive or negative value.

In an embodiment, the absolute value of the combined focal length of the third lens to the seventh lens may be greater than the combined focal length of the first lens and the second lens.

The first lens may have positive refractive power. Also, the first lens may have a meniscus shape convex toward the object side. For example, an object-side surface of the first lens may be convex in a paraxial region, and an image-side surface of the first lens may be concave in a paraxial region.

The second lens may have negative refractive power. Also, the second lens may have a meniscus shape convex toward the object side. For example, an object-side surface of the second lens may be convex in a paraxial region, and an image-side surface of the second lens may be concave in a paraxial region.

The third lens may have negative refractive power. Also, the third lens may have a meniscus shape convex toward the object side. For example, an object-side surface of the third lens may be convex in a paraxial region, and an image-side surface of the third lens may be concave in a paraxial region.

The fourth lens may have positive or negative refractive power. Also, both surfaces of the fourth lens may be convex. For example, an object-side surface and an image-side surface of the fourth lens may be convex in a paraxial region. Alternatively, the fourth lens may have a meniscus shape convex toward the object side. For example, an object-side surface of the fourth lens may be convex in a paraxial region, and an image-side surface of the fourth lens may be concave in a paraxial region.

The fifth lens may have positive refractive power. Also, both surfaces of the fifth lens may be convex. For example, an object-side surface and an image-side surface of the fifth lens may be convex in a paraxial region. Alternatively, the fifth lens may have a meniscus shape convex toward the object side. For example, an object-side surface of a fifth lens may be convex in a paraxial region, and an image-side surface of the fifth lens may be concave in a paraxial region.

A sixth lens may have positive refractive power. Also, the sixth lens may have a meniscus shape convex toward the object side. For example, an object-side surface of the sixth lens may be convex in a paraxial region, and an image-side surface of the sixth lens may be concave in a paraxial region.

A seventh lens may have negative refractive power. Also, the seventh lens may have a meniscus shape convex toward the object side. For example, an object-side surface of the seventh lens may be convex in a paraxial region, and an image-side surface of the seventh lens may be concave in a paraxial region. Alternatively, both surfaces of the seventh lens may be concave. For example, an object-side surface and an image-side surface of the seventh lens may be concave in a paraxial region.

Also, one or more of the sixth lens and the seventh lens may have at least one inflection point formed on at least one of an object-side surface and an image-side surface. For example, an object-side surface of the sixth lens may be convex in a paraxial region and may be concave in a portion other than an paraxial region. An image-side surface of the seventh lens may be concave in a paraxial region and may be convex in a portion other than the paraxial region.

The optical imaging system may be configured to have a field of view greater than 60°. In one embodiment, the field of view of the optical imaging system may be less than 65°.

In one embodiment, the field of view of the optical imaging system may be configured to have approximately 1× magnification based on 35 mm film. Accordingly, image quality of the optical imaging system may be improved.

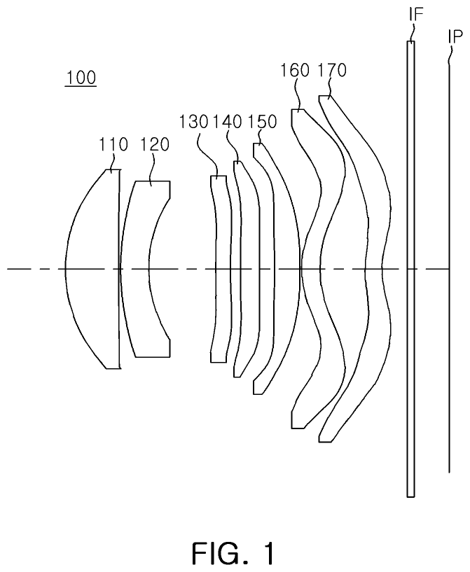

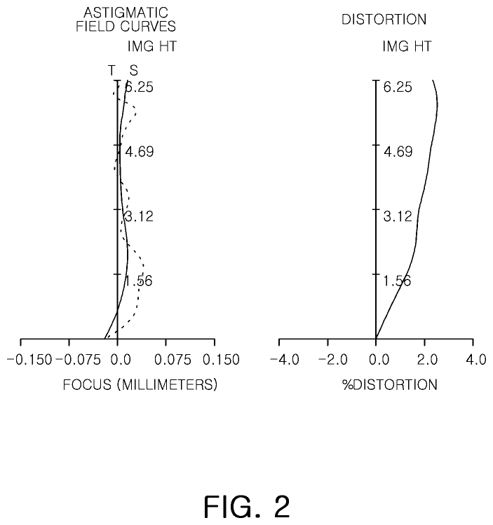

An optical imaging system 100 according to a first embodiment may be described with reference to FIGS. 1 and 2.

The optical imaging system 100 according to the first embodiment may include a first lens 110, a second lens 120, a third lens 130, a fourth lens 140, a fifth lens 150, a sixth lens 160, and a seventh lens 170, and may further include a filter IF and an image sensor.

A stop may be disposed between the second lens 120 and the third lens 130.

The optical imaging system 100 according to the first embodiment may form a focus on an imaging plane IP.

The lens characteristics (a radius, a thickness of lens or a distance between lenses, a refractive index, and an Abbe number) of each lens may be as in Table 1.

TABLE 1

| Surface | | Radius of | Thickness or | Refractive | Abbe | Effective |
|---|---|---|---|---|---|---|
| No. | Element | curvature | distance | index | number | radius |
| S1 | First lens | 4.277 | 1.641 | 1.546 | 55.99 | 2.971 |
| S2 | | 70.905 | 0.050 | | | 2.841 |
| S3 | Second lens | 6.094 | 0.863 | 1.677 | 19.24 | 2.622 |
| S4 | | 3.607 | 1.252 | | | 2.166 |
| S5 | Stop | Infinity | 0.805 | | | 2.027 |
| S6 | Third lens | 19.799 | 0.454 | 1.667 | 20.38 | 2.550 |
| S7 | | 13.892 | 0.316 | | | 2.773 |
| S8 | Fourth lens | 34.002 | 0.572 | 1.5458 | 55.99 | 3.019 |
| S9 | | 22.526 | 0.465 | | | 3.197 |
| S10 | Fifth lens | 625.763 | 0.777 | 1.570 | 37.40 | 3.426 |
| S11 | | −31.602 | 0.050 | | | 3.713 |
| S12 | Sixth lens | 3.109 | 0.572 | 1.5458 | 55.99 | 4.407 |
| S13 | | 4.725 | 1.378 | | | 4.740 |
| S14 | Seventh lens | 3.662 | 0.518 | 1.537 | 55.74 | 4.945 |
| S15 | | 2.397 | 0.782 | | | 5.141 |
| S16 | Filter | Infinity | 0.210 | 1.518 | 64.17 | |
| S17 | | Infinity | 1.074 | | | |
| S18 | Imaging plane | Infinity | | | | |

In the first embodiment, the first lens 110 may have positive refractive power, an object-side surface of the first lens 110 may be convex in a paraxial region, and an image-side surface of the first lens 110 may be concave in a paraxial region.

The second lens 120 may have negative refractive power, an object-side surface of the second lens 120 may be convex in a paraxial region, and an image-side surface of the second lens 120 may be concave in a paraxial region.

The third lens 130 may have negative refractive power, an object-side surface of the third lens 130 may be convex in a paraxial region, and an image-side surface of the third lens 130 may be concave in a paraxial region.

The fourth lens 140 may have negative refractive power, an object-side surface of the fourth lens 140 may be convex in a paraxial region, and an image-side surface of the fourth lens 140 may be concave in a paraxial region.

The fifth lens 150 may have positive refractive power, an object-side surface and an image-side surface of the fifth lens 150 may be convex in a paraxial region.

The sixth lens 160 may have positive refractive power, an object-side surface of the sixth lens 160 may be convex in a paraxial region, and an image-side surface of the sixth lens 160 may be concave in a paraxial region.

The seventh lens 170 may have negative refractive power, an object-side surface of the seventh lens 170 may be convex in a paraxial region, and an image-side surface of the seventh lens 170 may be concave in a paraxial region.

Also, one or more of the sixth lens 160 and the seventh lens 170 may have at least one inflection point on at least one of an object-side surface and an image-side surface.

Each surface of the first lens 110 to the seventh lens 170 may have an aspherical coefficient as in Table 2. For example, object-side surfaces and image-side surfaces of the first lens 110 to the seventh lens 170 may be aspherical.

TABLE 2

| | S1 | S2 | S3 | S4 | S6 | S7 | S8 |
|---|---|---|---|---|---|---|---|
| K | −1.138 | 90.000 | −4.969 | −0.754 | 3.779 | 6.967 | −80.367 |
| A | 1.643E−03 | −1.954E−02 | −1.844E−02 | −6.663E−03 | −1.245E−02 | −1.807E−02 | −2.904E−02 |
| B | 1.044E−03 | 2.667E−02 | 2.058E−02 | 7.695E−03 | 9.666E−03 | 2.032E−02 | 4.082E−02 |
| C | −1.427E−03 | −2.591E−02 | −1.821E−02 | −1.779E−02 | −1.241E−02 | −1.987E−02 | −2.735E−02 |
| D | 1.220E−03 | 1.898E−02 | 1.227E−02 | 3.148E−02 | 9.283E−03 | 1.132E−02 | 7.733E−03 |
| E | −6.860E−04 | −1.038E−02 | −6.079E−03 | −3.827E−02 | −4.281E−03 | −3.912E−03 | 1.166E−03 |
| F | 2.664E−04 | 4.226E−03 | 2.182E−03 | 3.278E−02 | 1.197E−03 | 7.406E−04 | −1.922E−03 |
| G | −7.351E−05 | −1.284E−03 | −5.569E−04 | −2.014E−02 | −1.755E−04 | −2.175E−05 | 8.407E−04 |
| H | 1.462E−05 | 2.909E−04 | 9.664E−05 | 8.962E−03 | 2.350E−06 | −2.693E−05 | −2.205E−04 |
| J | −2.100E−06 | −4.880E−05 | −1.006E−05 | −2.887E−03 | 3.315E−06 | 7.685E−06 | 3.911E−05 |
| L | 2.154E−07 | 5.969E−06 | 2.902E−07 | 6.660E−04 | −3.273E−07 | −1.104E−06 | −4.834E−06 |
| M | −1.536E−08 | −5.168E−07 | 7.616E−08 | −1.071E−04 | −4.622E−08 | 9.384E−08 | 4.127E−07 |
| N | 7.214E−10 | 2.998E−08 | −1.169E−08 | 1.139E−05 | 1.251E−08 | −4.567E−09 | −2.326E−08 |
| O | −1.997E−11 | −1.045E−09 | 7.197E−10 | −7.196E−07 | −1.043E−09 | 1.041E−10 | 7.800E−10 |
| P | 2.454E−13 | 1.653E−11 | −1.743E−11 | 2.043E−08 | 3.185E−11 | −3.932E−13 | −1.178E−11 |

| | S9 | S10 | S11 | S12 | S13 | S14 | S15 |
|---|---|---|---|---|---|---|---|
| K | −68.768 | 90.000 | −84.274 | −2.094 | −5.944 | −19.082 | −0.996 |
| A | −4.629E−02 | −5.249E−02 | −4.462E−02 | 2.809E−02 | 5.976E−02 | −1.341E−02 | −6.441E−02 |
| B | 5.403E−02 | 5.959E−02 | 2.989E−02 | −1.947E−02 | −2.936E−02 | −1.033E−02 | 1.367E−02 |
| C | −3.221E−02 | −3.449E−02 | −1.609E−02 | 7.050E−03 | 9.020E−03 | 6.235E−03 | −3.020E−03 |
| D | 1.089E−02 | 1.356E−02 | 7.217E−03 | −2.130E−03 | −2.203E−03 | −2.071E−03 | 6.111E−04 |
| E | −2.099E−03 | −4.077E−03 | −2.625E−03 | 5.027E−04 | 4.281E−04 | 4.726E−04 | −1.044E−04 |
| F | 1.615E−04 | 9.695E−04 | 7.267E−04 | −8.983E−05 | −6.432E−05 | −7.470E−05 | 1.446E−05 |
| G | 2.236E−05 | −1.808E−04 | −1.480E−04 | 1.198E−05 | 7.328E−06 | 8.237E−06 | −1.551E−06 |
| H | −7.353E−06 | 2.579E−05 | 2.192E−05 | −1.176E−06 | −6.265E−07 | −6.415E−07 | 1.235E−07 |
| J | 7.767E−07 | −2.737E−06 | −2.346E−06 | 8.366E−08 | 3.979E−08 | 3.551E−08 | −7.103E−09 |
| L | −1.699E−08 | 2.099E−07 | 1.791E−07 | −4.235E−09 | −1.846E−09 | −1.390E−09 | 2.891E−10 |
| M | −4.516E−09 | −1.120E−08 | −9.489E−09 | 1.482E−10 | 6.063E−11 | 3.764E−11 | −8.092E−12 |
| N | 5.195E−10 | 3.914E−10 | 3.311E−10 | −3.403E−12 | −1.334E−12 | −6.712E−13 | 1.480E−13 |
| O | −2.390E−11 | −7.998E−12 | −6.834E−12 | 4.610E−14 | 1.760E−14 | 7.096E−15 | −1.592E−15 |
| P | 4.271E−13 | 7.190E−14 | 6.314E−14 | −2.794E−16 | −1.050E−16 | −3.371E−17 | 7.647E−18 |

Also, the optical imaging system configured as described above may have the aberration properties illustrated in FIG. 2.

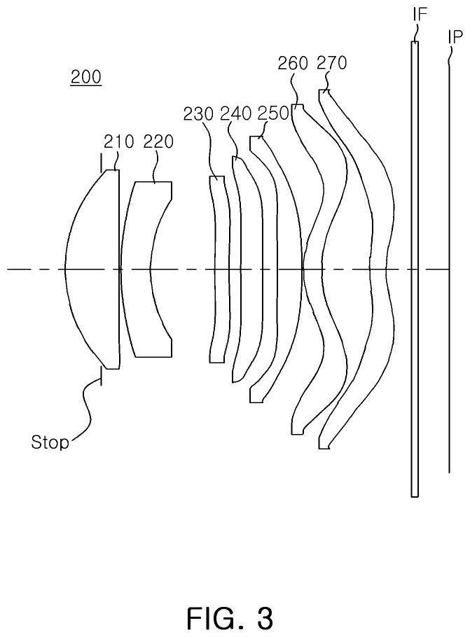

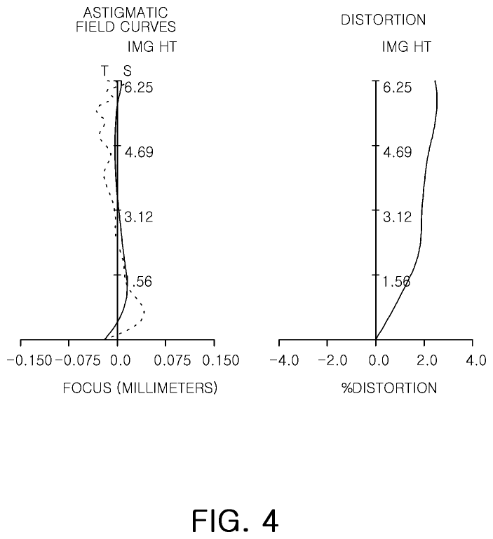

An optical imaging system 200 according to a second embodiment may be described with reference to FIGS. 3 and 4.

The optical imaging system 200 according to the second embodiment may include a first lens 210, a second lens 220, a third lens 230, a fourth lens 240, a fifth lens 250, a sixth lens 260, and a seventh lens 270, and may further include a filter IF and an image sensor.

A stop may be disposed on the front side (object side) of the first lens 210 and between the second lens 220 and the third lens 230.

The optical imaging system 200 according to the second embodiment may form a focus on an imaging plane IP.

The lens characteristics (a radius, a thickness of lens or a distance between lenses, a refractive index, and an Abbe number) of each lens may be as in Table 3.

TABLE 3

| Sur- | | | Thick- | Refrac- | | Effec- |
|---|---|---|---|---|---|---|
| face | | Radius of | ness or | tive | Abbe | tive |
| No. | Element | curvature | distance | index | number | radius |
| S1 | Stop | Infinity | −1.100 | | | 2.972 |
| S2 | First lens | 4.264 | 1.654 | 1.546 | 55.99 | 2.972 |
| S3 | | 74.143 | 0.050 | | | 2.836 |
| S4 | Second lens | 6.236 | 0.912 | 1.677 | 19.24 | 2.619 |
| S5 | | 3.607 | 1.197 | | | 2.145 |
| S6 | Stop | Infinity | 0.774 | | | 2.026 |
| S7 | Third lens | 20.776 | 0.438 | 1.667 | 20.38 | 2.544 |
| S8 | | 14.750 | 0.364 | | | 2.754 |
| S9 | Fourth lens | 42.661 | 0.666 | 1.546 | 55.99 | 3.117 |
| S10 | | 28.466 | 0.458 | | | 3.246 |
| S11 | Fifth lens | 104.695 | 0.746 | 1.570 | 37.40 | 3.661 |
| S12 | | −65.604 | 0.050 | | | 3.790 |
| S13 | Sixth lens | 3.002 | 0.560 | 1.546 | 55.99 | 4.751 |
| S14 | | 4.614 | 1.469 | | | 4.761 |
| S15 | Seventh lens | 3.912 | 0.500 | 1.537 | 55.74 | 5.184 |
| S16 | | 2.480 | 0.782 | | | 5.150 |
| S17 | Filter | Infinity | 0.210 | 1.518 | 64.17 | |
| S18 | | Infinity | 0.951 | | | |
| S19 | Imaging plane | Infinity | | | | |

In the second embodiment, the first lens 210 may have positive refractive power, an object-side surface of the first lens 210 may be convex in a paraxial region, and an image-side surface of the first lens 210 may be concave in a paraxial region.

The second lens 220 may have negative refractive power, an object-side surface of the second lens 220 may be convex in a paraxial region, and an image-side surface of the second lens 220 may be concave in a paraxial region.

The third lens 230 may have negative refractive power, an object-side surface of the third lens 230 may be convex in a paraxial region, and an image-side surface of the third lens 230 may be concave in a paraxial region.

The fourth lens 240 may have negative refractive power, an object-side surface of the fourth lens 240 may be convex in a paraxial region, and an image-side surface of the fourth lens 240 may be concave in a paraxial region.

The fifth lens 250 may have positive refractive power, an object-side surface and an image-side surface of the fifth lens 250 may be convex in a paraxial region.

The sixth lens 260 may have positive refractive power, an object-side surface of the sixth lens 260 may be convex in a paraxial region, and an image-side surface of the sixth lens 260 may be concave in a paraxial region.

The seventh lens 270 may have negative refractive power, an object-side surface of the seventh lens 270 may be convex in a paraxial region, and an image-side surface of the seventh lens 270 may be concave in a paraxial region.

Also, one or more of the sixth lens 260 and the seventh lens 270 may have at least one inflection point on at least one of an object-side surface and an image-side surface.

Each surface of the first lens 210 to the seventh lens 270 may have an aspherical coefficient as in Table 4. For example, object-side surfaces and image-side surfaces of the first lens 210 to the seventh lens 270 may be aspherical.

TABLE 4

| | S2 | S3 | S4 | S5 | S7 | S8 | S9 |
|---|---|---|---|---|---|---|---|
| K | −1.125 | 89.995 | −4.993 | −0.685 | 10.390 | 7.883 | −89.999 |
| A | 2.048E−03 | −1.957E−02 | −1.896E−02 | −6.652E−03 | −1.305E−02 | −1.794E−02 | −2.716E−02 |
| B | 1.420E−05 | 2.558E−02 | 2.235E−02 | 9.238E−03 | 1.211E−02 | 2.003E−02 | 3.903E−02 |
| C | −7.152E−05 | −2.363E−02 | −2.179E−02 | −2.252E−02 | −1.704E−02 | −1.991E−02 | −3.028E−02 |
| D | 1.127E−04 | 1.642E−02 | 1.693E−02 | 4.010E−02 | 1.541E−02 | 1.219E−02 | 1.450E−02 |
| E | −8.457E−05 | −8.499E−03 | −1.010E−02 | −4.865E−02 | −9.963E−03 | −5.124E−03 | −4.719E−03 |
| F | 3.950E−05 | 3.268E−03 | 4.571E−03 | 4.150E−02 | 4.850E−03 | 1.578E−03 | 1.084E−03 |
| G | −1.229E−05 | −9.342E−04 | −1.564E−03 | −2.542E−02 | −1.821E−03 | −3.795E−04 | −1.765E−04 |
| H | 2.612E−06 | 1.985E−04 | 4.030E−04 | 1.130E−02 | 5.286E−04 | 7.582E−05 | 1.916E−05 |
| J | −3.807E−07 | −3.113E−05 | −7.737E−05 | −3.644E−03 | −1.170E−04 | −1.290E−05 | −9.673E−07 |
| L | 3.737E−08 | 3.550E−06 | 1.088E−05 | 8.431E−04 | 1.921E−05 | 1.797E−06 | −8.079E−08 |
| M | −2.354E−09 | −2.858E−07 | −1.086E−06 | −1.362E−04 | −2.252E−06 | −1.895E−07 | 2.103E−08 |
| N | 8.522E−11 | 1.537E−08 | 7.266E−08 | 1.458E−05 | 1.773E−07 | 1.375E−08 | −1.928E−09 |
| O | −1.284E−12 | −4.954E−10 | −2.921E−09 | −9.285E−07 | −8.369E−09 | −6.024E−10 | 8.884E−11 |
| P | −3.645E−15 | 7.225E−12 | 5.323E−11 | 2.660E−08 | 1.788E−10 | 1.193E−11 | −1.698E−12 |
| | S10 | S11 | S12 | S13 | S14 | S15 | S16 |
| K | −75.377 | 90.000 | −90.000 | −2.148 | −5.988 | −22.198 | −0.998 |
| A | −4.453E−02 | −5.073E−02 | −3.991E−02 | 2.761E−02 | 5.712E−02 | −1.376E−02 | −6.151E−02 |
| B | 4.978E−02 | 5.875E−02 | 2.460E−02 | −2.016E−02 | −2.771E−02 | −1.010E−02 | 1.253E−02 |
| C | −2.939E−02 | −3.500E−02 | −1.172E−02 | 7.789E−03 | 8.566E−03 | 6.151E−03 | −2.620E−03 |
| D | 1.007E−02 | 1.398E−02 | 4.447E−03 | −2.398E−03 | −2.093E−03 | −2.028E−03 | 5.076E−04 |
| E | −1.940E−03 | −4.118E−03 | −1.372E−03 | 5.559E−04 | 3.980E−04 | 4.562E−04 | −8.552E−05 |
| F | 7.796E−05 | 9.152E−04 | 3.307E−04 | −9.609E−05 | −5.747E−05 | −7.128E−05 | 1.192E−05 |
| G | 7.217E−05 | −1.529E−04 | −6.022E−05 | 1.237E−05 | 6.238E−06 | 7.809E−06 | −1.293E−06 |
| H | −2.462E−05 | 1.892E−05 | 8.152E−06 | −1.174E−06 | −5.067E−07 | −6.074E−07 | 1.039E−07 |
| J | 4.443E−06 | −1.697E−06 | −8.129E−07 | 8.108E−08 | 3.059E−08 | 3.374E−08 | −6.019E−09 |
| L | −5.201E−07 | 1.064E−07 | 5.880E−08 | −3.996E−09 | −1.353E−09 | −1.331E−09 | 2.460E−10 |
| M | 4.061E−08 | −4.383E−09 | −2.994E−09 | 1.363E−10 | 4.252E−11 | 3.643E−11 | −6.904E−12 |
| N | −2.046E−09 | 1.046E−10 | 1.015E−10 | −3.052E−12 | −8.987E−13 | −6.587E−13 | 1.265E−13 |
| O | 6.022E−11 | −9.968E−13 | −2.052E−12 | 4.026E−14 | 1.143E−14 | 7.077E−15 | −1.363E−15 |
| P | −7.872E−13 | −3.656E−15 | 1.865E−14 | −2.371E−16 | −6.598E−17 | −3.422E−17 | 6.550E−18 |

Also, the optical imaging system configured as described above may have the aberration properties illustrated in FIG. 4.

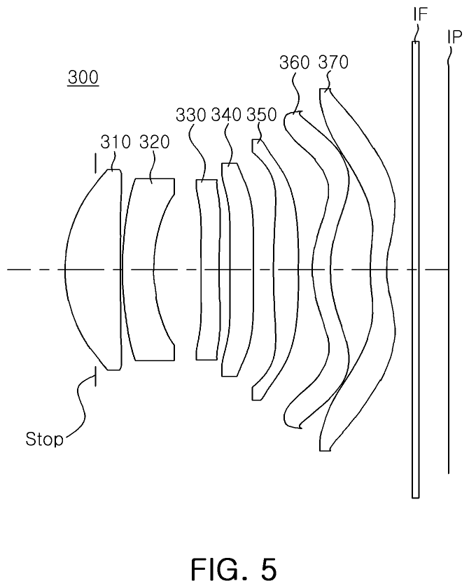

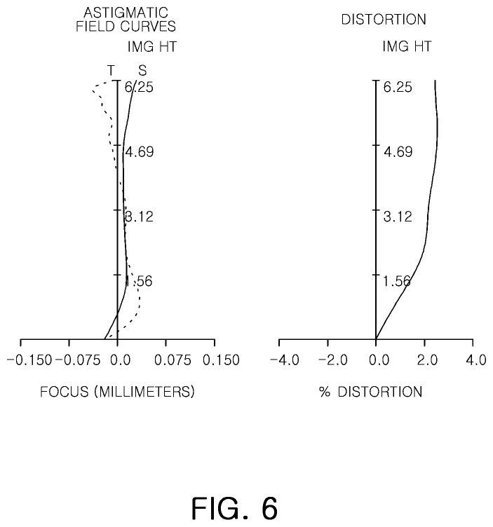

An optical imaging system 300 according to a third embodiment may be described with reference to FIGS. 5 and 6.

The optical imaging system 300 according to the third embodiment may include a first lens 310, a second lens 320, a third lens 330, a fourth lens 340, a fifth lens 350, a sixth lens 360, and a seventh lens 370, and may further include a filter IF and an image sensor.

A stop may be disposed on the front side of the first lens 310 and between the second lens 320 and the third lens 330.

The optical imaging system 300 according to the third embodiment may form a focus on an imaging plane IP.

The lens characteristics (a radius, a thickness of lens or a distance between lenses, a refractive index, and an Abbe number) of each lens may be as in Table 5.

TABLE 5

| Sur- | | | Thick- | Refrac- | | Effec- |
|---|---|---|---|---|---|---|
| face | | Radius of | ness or | tive | Abbe | tive |
| No. | Element | curvature | distance | index | number | radius |
| S1 | Stop | Infinity | −0.938 | | | 2.975 |
| S2 | First lens | 4.168 | 1.698 | 1.546 | 55.99 | 2.997 |
| S3 | | 51.293 | 0.064 | | | 2.881 |
| S4 | Second lens | 8.259 | 0.952 | 1.677 | 19.24 | 2.712 |
| S5 | | 4.468 | 0.963 | | | 2.254 |
| S6 | Stop | Infinity | 0.488 | | | 2.201 |
| S7 | Third lens | 20.439 | 0.563 | 1.677 | 19.24 | 2.435 |
| S8 | | 13.294 | 0.341 | | | 2.687 |
| S9 | Fourth lens | 76.662 | 0.714 | 1.546 | 55.99 | 2.881 |
| S10 | | 52.437 | 0.611 | | | 3.124 |
| S11 | Fifth lens | 14.252 | 0.768 | 1.570 | 37.40 | 3.607 |
| S12 | | 51.798 | 0.427 | | | 3.732 |
| S13 | Sixth lens | 3.407 | 0.560 | 1.546 | 55.99 | 4.624 |
| S14 | | 5.016 | 1.221 | | | 4.671 |
| S15 | Seventh lens | 4.644 | 0.500 | 1.537 | 55.74 | 5.239 |
| S16 | | 2.607 | 0.782 | | | 5.229 |
| S17 | Filter | Infinity | 0.210 | 1.518 | 64.17 | |
| S18 | | Infinity | 0.919 | | | |
| S19 | Imaging plane | Infinity | | | | |

In the third embodiment, the first lens 310 may have positive refractive power, an object-side surface of the first lens 310 may be convex in a paraxial region, and an image-side surface of the first lens 310 may be concave in a paraxial region.

The second lens 320 may have negative refractive power, an object-side surface of the second lens 320 may be convex in a paraxial region, and an image-side surface of the second lens 320 may be concave in a paraxial region.

The third lens 330 may have negative refractive power, an object-side surface of the third lens 330 may be convex in a paraxial region, and an image-side surface of the third lens 330 may be concave in a paraxial region.

The fourth lens 340 may have negative refractive power, an object-side surface of the fourth lens 340 may be convex in a paraxial region, and an image-side surface of the fourth lens 340 may be concave in a paraxial region.

The fifth lens 350 may have positive refractive power, an object-side surface of the fifth lens 350 may be convex in a paraxial region, and an image-side surface of the fifth lens 350 may be concave in a paraxial region.

The sixth lens 360 may have positive refractive power, an object-side surface of the sixth lens 360 may be convex in a paraxial region, and an image-side surface of the sixth lens 360 may be concave in a paraxial region.

The seventh lens 370 may have negative refractive power, an object-side surface of the seventh lens 370 may be convex in a paraxial region, and an image-side surface of the seventh lens 370 may be concave in a paraxial region.

Also, one or more of the sixth lens 360 and the seventh lens 370 may have at least one inflection point on at least one of an object-side surface and an image-side surface.

Each surface of the first lens 310 to the seventh lens 370 may have an aspherical coefficient as in Table 6. For example, object-side surfaces and image-side surfaces of the first lens 310 to the seventh lens 370 may be aspherical.

TABLE 6

| | S2 | S3 | S4 | S5 | S7 | S8 | S9 |
|---|---|---|---|---|---|---|---|
| K | −1.110 | 48.289 | −4.489 | −0.553 | 14.766 | 12.010 | 57.914 |
| A | 2.073E−03 | −1.343E−02 | −1.345E−02 | −4.073E−03 | −1.133E−02 | −1.011E−02 | −7.806E−03 |
| B | 2.182E−04 | 1.172E−02 | 8.492E−03 | 2.190E−04 | 7.271E−03 | 4.912E−03 | 9.970E−03 |
| C | −5.576E−04 | −7.079E−03 | −2.891E−03 | 2.784E−03 | −1.269E−02 | −7.024E−03 | −1.086E−02 |
| D | 7.063E−04 | 3.421E−03 | −4.070E−04 | −6.154E−03 | 1.346E−02 | 5.644E−03 | 6.512E−03 |
| E | −5.295E−04 | −1.313E−03 | 1.272E−03 | 8.763E−03 | −9.461E−03 | −3.051E−03 | −2.352E−03 |
| F | 2.620E−04 | 3.879E−04 | −8.883E−04 | −8.408E−03 | 4.637E−03 | 1.207E−03 | 4.252E−04 |
| G | −8.964E−05 | −8.463E−05 | 3.771E−04 | 5.569E−03 | −1.634E−03 | −3.691E−04 | 3.414E−05 |
| H | 2.170E−05 | 1.280E−05 | −1.102E−04 | −2.592E−03 | 4.223E−04 | 9.027E−05 | −4.472E−05 |
| J | −3.748E−06 | −1.161E−06 | 2.295E−05 | 8.549E−04 | −8.106E−05 | −1.771E−05 | 1.370E−05 |
| L | 4.590E−07 | 2.511E−08 | −3.414E−06 | −1.987E−04 | 1.162E−05 | 2.709E−06 | −2.428E−06 |
| M | −3.896E−08 | 7.817E−09 | 3.552E−07 | 3.186E−05 | −1.235E−06 | −3.068E−07 | 2.733E−07 |
| N | 2.179E−09 | −1.028E−09 | −2.459E−08 | −3.353E−06 | 9.369E−08 | 2.386E−08 | −1.930E−08 |
| O | −7.231E−11 | 5.561E−11 | 1.018E−09 | 2.085E−07 | −4.572E−09 | −1.124E−09 | 7.808E−10 |
| P | 1.078E−12 | −1.187E−12 | −1.907E−11 | −5.811E−09 | 1.073E−10 | 2.395E−11 | −1.383E−11 |
| | S10 | S11 | S12 | S13 | S14 | S15 | S16 |
| K | −90.000 | 8.247 | 50.779 | −2.501 | −12.870 | −35.234 | −0.987 |
| A | −1.127E−02 | −1.598E−02 | −2.266E−02 | 1.132E−02 | 3.958E−02 | −6.425E−03 | −5.148E−02 |
| B | 8.337E−03 | 1.089E−02 | 4.143E−03 | −1.149E−02 | −1.861E−02 | −1.496E−02 | 6.724E−03 |
| C | −5.184E−03 | −4.581E−03 | 2.522E−03 | 5.527E−03 | 6.262E−03 | 7.870E−03 | −2.651E−04 |
| D | 1.501E−03 | 1.045E−03 | −2.577E−03 | −2.067E−03 | −1.784E−03 | −2.395E−03 | −1.598E−04 |
| E | −2.279E−05 | −7.882E−05 | 1.150E−03 | 5.410E−04 | 3.897E−04 | 4.999E−04 | 4.885E−05 |
| F | −1.549E−04 | −3.004E−05 | −3.273E−04 | −9.975E−05 | −6.276E−05 | −7.349E−05 | −7.620E−06 |
| G | 6.651E−05 | 1.185E−05 | 6.464E−05 | 1.314E−05 | 7.416E−06 | 7.685E−06 | 7.680E−07 |
| H | −1.566E−05 | −2.111E−06 | −9.110E−06 | −1.240E−06 | −6.441E−07 | −5.759E−07 | −5.323E−08 |
| J | 2.396E−06 | 2.206E−07 | 9.211E−07 | 8.338E−08 | 4.095E−08 | 3.098E−08 | 2.589E−09 |
| L | −2.458E−07 | −1.309E−08 | −6.614E−08 | −3.933E−09 | −1.879E−09 | −1.186E−09 | −8.828E−11 |
| M | 1.653E−08 | 2.911E−10 | 3.284E−09 | 1.263E−10 | 6.040E−11 | 3.158E−11 | 2.063E−12 |
| N | −6.794E−10 | 1.246E−11 | −1.070E−10 | −2.613E−12 | −1.287E−12 | −5.556E−13 | −3.142E−14 |
| O | 1.448E−11 | −9.434E−13 | 2.054E−12 | 3.116E−14 | 1.629E−14 | 5.814E−15 | 2.799E−16 |
| P | −9.956E−14 | 1.759E−14 | −1.759E−14 | −1.610E−16 | −9.236E−17 | −2.741E−17 | −1.101E−18 |

Also, the optical imaging system configured as described above may have the aberration properties illustrated in FIG. 6.

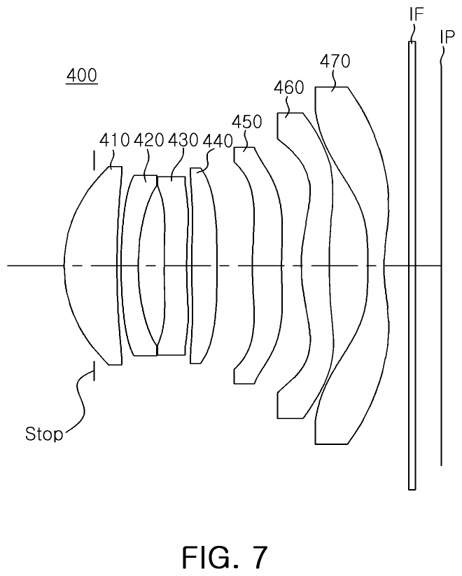

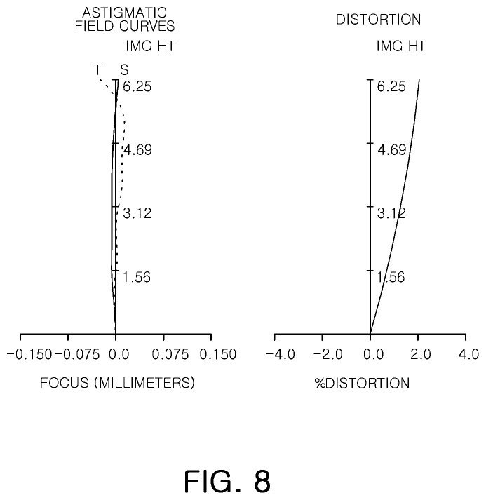

An optical imaging system 400 according to a fourth embodiment may be described with reference to FIGS. 7 and 8.

The optical imaging system 400 according to the fourth embodiment may include a first lens 410, a second lens 420, a third lens 430, a fourth lens 440, a fifth lens 450, a sixth lens 460, and a seventh lens 470, and may further include a filter IF and an image sensor.

A stop may be disposed on the front side of the first lens 410 and between the second lens 420 and the third lens 430.

The optical imaging system 400 according to the fourth embodiment may form a focus on an imaging plane IP.

The lens characteristics (a radius, a thickness of lens or a distance between lenses, a refractive index, and an Abbe number) of each lens may be as in Table 7.

TABLE 7

| Sur- | | | Thick- | Refrac- | | Effec- |
|---|---|---|---|---|---|---|
| face | | Radius of | ness or | tive | Abbe | tive |
| No. | Element | curvature | distance | index | number | radius |
| S1 | Stop | Infinity | −0.938 | | | 2.988 |
| S2 | First lens | 4.035 | 1.652 | 1.546 | 55.99 | 2.988 |
| S3 | | 16.092 | 0.125 | | | 2.833 |
| S4 | Second lens | 10.662 | 0.538 | 1.677 | 19.24 | 2.682 |
| S5 | | 6.425 | 0.573 | | | 2.364 |
| S6 | Stop | Infinity | 0.236 | | | 2.335 |
| S7 | Third lens | 20.777 | 0.700 | 1.677 | 19.24 | 2.362 |
| S8 | | 12.516 | 0.163 | | | 2.631 |
| S9 | Fourth lens | 27.264 | 0.790 | 1.546 | 55.99 | 2.813 |
| S10 | | −65.896 | 1.106 | | | 2.886 |
| S11 | Fifth lens | 12.546 | 0.904 | 1.570 | 37.40 | 3.234 |
| S12 | | 13.099 | 0.618 | | | 3.468 |
| S13 | Sixth lens | 4.987 | 0.870 | 1.546 | 55.99 | 3.965 |
| S14 | | 19.208 | 1.209 | | | 4.411 |
| S15 | Seventh lens | −41.344 | 0.500 | 1.537 | 55.74 | 4.839 |
| S16 | | 4.367 | 0.782 | | | 5.154 |
| S17 | Filter | Infinity | 0.210 | 1.518 | 64.17 | |
| S18 | | Infinity | 0.805 | | | |
| S19 | Imaging plane | Infinity | | | | |

In the fourth embodiment, the first lens 410 may have positive refractive power, an object-side surface of the first lens 410 may be convex in a paraxial region, and an image-side surface of the first lens 410 may be concave in a paraxial region.

The second lens 420 may have negative refractive power, an object-side surface of the second lens 420 may be convex in a paraxial region, and an image-side surface of the second lens 420 may be concave in a paraxial region.

The third lens 430 may have negative refractive power, an object-side surface of the third lens 430 may be convex in a paraxial region, and an image-side surface of the third lens 430 may be concave in a paraxial region.

The fourth lens 440 may have positive refractive power, and an object-side surface and an image-side surface of the fourth lens 440 may be convex in a paraxial region.

The fifth lens 450 may have positive refractive power, and an object-side surface of the fifth lens 450 may be convex in a paraxial region, and an image-side surface of the fifth lens 450 may be concave in a paraxial region.

The sixth lens 460 may have positive refractive power, an object-side surface of the sixth lens 460 may be convex in a paraxial region, and an image-side surface of the sixth lens 460 may be concave in a paraxial region.

The seventh lens 470 may have negative refractive power, and an object-side surface and an image-side surface of the seventh lens 470 may be concave in a paraxial region.

Also, one or more of the sixth lens 460 and the seventh lens 470 may have at least one inflection point on at least one of an object-side surface and an image-side surface.

Each surface of the first lens 410 to the seventh lens 470 may have an aspherical coefficient as in Table 8. For example, object-side surfaces and image-side surfaces of the first lens 410 to the seventh lens 470 may be aspherical.

TABLE 8

| | S2 | S3 | S4 | S5 | S7 | S8 | S9 |
|---|---|---|---|---|---|---|---|
| K | −1.046 | −34.431 | −1.268 | −0.020 | −3.112 | 12.204 | 31.488 |
| A | 1.980E−03 | −1.329E−02 | −1.646E−02 | −5.958E−03 | −9.609E−03 | −1.269E−02 | −9.418E−03 |
| B | −1.561E−04 | 8.427E−03 | 1.025E−02 | 4.104E−03 | 1.983E−03 | 5.117E−03 | 5.391E−03 |
| C | 2.086E−04 | −3.187E−03 | −3.682E−03 | −1.066E−03 | −1.315E−03 | −2.585E−03 | −1.968E−03 |
| D | −9.641E−05 | 8.155E−04 | 8.662E−04 | −1.011E−05 | 4.371E−04 | 5.366E−04 | 9.468E−05 |
| E | 2.631E−05 | −1.441E−04 | −1.303E−04 | 1.065E−04 | −9.417E−05 | −2.796E−05 | 1.163E−04 |
| F | −4.369E−06 | 1.721E−05 | 1.153E−05 | −3.631E−05 | 1.361E−05 | −6.309E−06 | −3.257E−05 |
| G | 4.331E−07 | −1.311E−06 | −4.193E−07 | 6.083E−06 | −1.243E−06 | 1.095E−06 | 3.816E−06 |
| H | −2.353E−08 | 5.652E−08 | −1.260E−08 | −5.269E−07 | 6.654E−08 | −6.020E−08 | −2.123E−07 |
| J | 5.340E−10 | −1.031E−09 | 1.152E−09 | 1.889E−08 | −1.676E−09 | 9.586E−10 | 4.564E−09 |
| L | 0.000E+00 | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 | 0.000E+00 |
| | S10 | S11 | S12 | S13 | S14 | S15 | S16 |
| K | 60.066 | −9.949 | −6.266 | −2.605 | −90.000 | −29.584 | −0.759 |
| A | −7.736E−03 | −1.007E−02 | −1.715E−02 | −1.785E−03 | 1.317E−02 | −2.597E−02 | −3.249E−02 |
| B | 1.799E−03 | 5.040E−04 | −4.026E−05 | −4.353E−03 | −5.762E−03 | 2.503E−03 | 5.093E−03 |
| C | −4.826E−04 | 6.457E−04 | 1.426E−03 | 1.618E−03 | 1.198E−03 | −5.120E−06 | −6.652E−04 |
| D | 4.781E−05 | −4.158E−04 | −6.745E−04 | −4.154E−04 | −1.570E−04 | −2.525E−05 | 7.087E−05 |
| E | 7.209E−06 | 1.073E−04 | 1.865E−04 | 8.192E−05 | 1.234E−05 | 3.603E−06 | −6.016E−06 |
| F | −2.352E−06 | −8.093E−06 | −3.592E−05 | −1.272E−05 | −4.181E−07 | −2.985E−07 | 3.935E−07 |
| G | 2.274E−07 | −3.312E−06 | 5.071E−06 | 1.514E−06 | −2.129E−08 | 1.677E−08 | −1.930E−08 |
| H | −9.221E−09 | 1.263E−06 | −5.310E−07 | −1.339E−07 | 3.599E−09 | −6.639E−10 | 6.970E−10 |
| J | 1.309E−10 | −2.219E−07 | 4.108E−08 | 8.616E−09 | −2.266E−10 | 1.871E−11 | −1.826E−11 |
| L | 0.000E+00 | 2.391E−08 | −2.307E−09 | −3.945E−10 | 8.520E−12 | −3.731E−13 | 3.410E−13 |
| M | 0.000E+00 | −1.658E−09 | 9.103E−11 | 1.247E−11 | −2.038E−13 | 5.134E−15 | −4.411E−15 |
| N | 0.000E+00 | 7.226E−11 | −2.380E−12 | −2.578E−13 | 3.038E−15 | −4.638E−17 | 3.748E−17 |
| O | 0.000E+00 | −1.805E−12 | 3.687E−14 | 3.134E−15 | −2.564E−17 | 2.473E−19 | −1.881E−19 |
| P | 0.000E+00 | 1.970E−14 | −2.555E−16 | −1.697E−17 | 9.306E−20 | −5.898E−22 | 4.222E−22 |

Also, the optical imaging system configured as described above may have the aberration properties illustrated in FIG. 8.

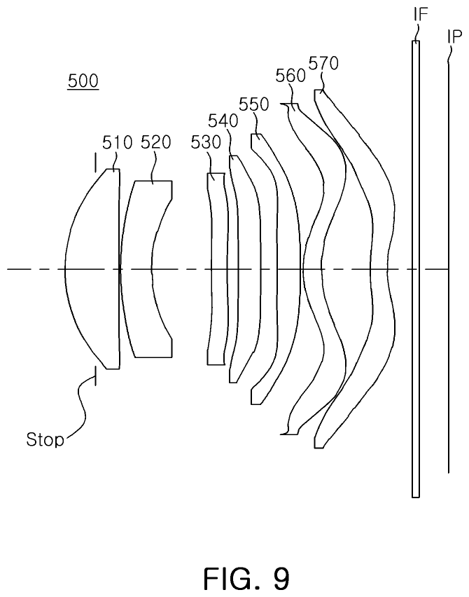

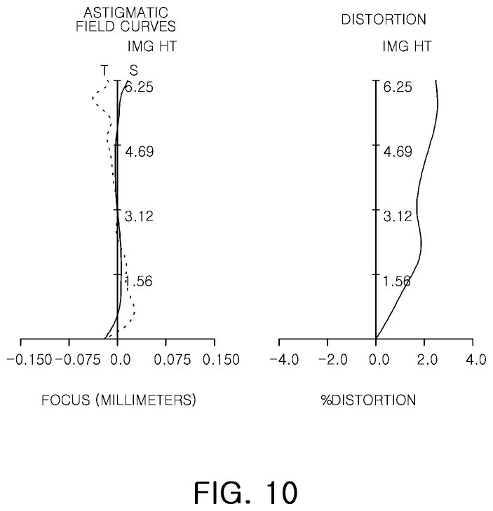

An optical imaging system 500 according to a fifth embodiment may be described with reference to FIGS. 9 and 10.

The optical imaging system 500 according to the fifth embodiment may include a first lens 510, a second lens 520, a third lens 530, a fourth lens 540, a fifth lens 550, a sixth lens 560, and a seventh lens 570, and may further include a filter IF and an image sensor.

A stop may be disposed on the front side of the first lens 510 and between the second lens 520 and the third lens 530.

The optical imaging system 500 according to the fifth embodiment may form a focus on an imaging plane IP.

The lens characteristics (a radius, a thickness of lens or a distance between lenses, a refractive index, and an Abbe number) of each lens may be as in Table 9.

TABLE 9

| Sur- | | | Thick- | Refrac- | | Effec- |
|---|---|---|---|---|---|---|
| face | | Radius of | ness or | tive | Abbe | tive |
| No. | Element | curvature | distance | index | number | radius |
| S1 | Stop | Infinity | −0.938 | | | 2.973 |
| S2 | First lens | 4.248 | 1.651 | 1.546 | 55.99 | 2.973 |
| S3 | | 63.759 | 0.053 | | | 2.838 |
| S4 | Second lens | 6.577 | 0.949 | 1.677 | 19.24 | 2.629 |
| S5 | | 3.746 | 1.095 | | | 2.149 |
| S6 | Stop | Infinity | 0.744 | | | 2.077 |
| S7 | Third lens | 19.616 | 0.487 | 1.667 | 20.38 | 2.571 |
| S8 | | 14.067 | 0.343 | | | 2.787 |
| S9 | Fourth lens | 90.890 | 0.689 | 1.546 | 55.99 | 3.129 |
| S10 | | 59.779 | 0.499 | | | 3.230 |
| S11 | Fifth lens | 37.756 | 0.714 | 1.570 | 37.40 | 3.710 |
| S12 | | 183.386 | 0.086 | | | 3.821 |
| S13 | Sixth lens | 3.097 | 0.560 | 1.546 | 55.99 | 4.761 |
| S14 | | 4.827 | 1.497 | | | 4.732 |
| S15 | Seventh lens | 4.349 | 0.519 | 1.537 | 55.74 | 5.165 |
| S16 | | 2.641 | 0.782 | | | 5.131 |
| S17 | Filter | Infinity | 0.210 | 1.518 | 64.17 | |
| S18 | | Infinity | 0.903 | | | |
| S19 | Imaging plane | Infinity | | | | |

In the fifth embodiment, the first lens 510 may have positive refractive power, an object-side surface of the first lens 510 may be convex in a paraxial region, and an image-side surface of the first lens 510 may be concave in a paraxial region.

The second lens 520 may have negative refractive power, an object-side surface of the second lens 520 may be convex in a paraxial region, and an image-side surface of the second lens 520 may be concave in a paraxial region.

The third lens 530 may have negative refractive power, an object-side surface of the third lens 530 may be convex in a paraxial region, and an image-side surface of the third lens 530 may be concave in a paraxial region.

The fourth lens 540 may have negative refractive power, an object-side surface of the fourth lens 540 may be convex in a paraxial region, and an image-side surface of the fourth lens 540 may be concave in a paraxial region.

The fifth lens 550 may have positive refractive power, an object-side surface of the fifth lens 550 may be convex in a paraxial region, and an image-side surface of the fifth lens 550 may be concave in a paraxial region.

The sixth lens 560 may have positive refractive power, an object-side surface of the sixth lens 560 may be convex in a paraxial region, and an image-side surface of the sixth lens 560 may be concave in a paraxial region.

The seventh lens 570 may have negative refractive power, an object-side surface of the seventh lens 570 may be convex in a paraxial region, and an image-side surface of the seventh lens 570 may be concave in a paraxial region.

Also, one or more of the sixth lens 560 and the seventh lens 570 may have at least one inflection point on at least one of an object-side surface and an image-side surface.

Each surface of the first lens 510 to the seventh lens 570 may have an aspherical coefficient as in Table 10. For example, object-side surfaces and image-side surfaces of the first lens 510 to the seventh lens 570 may be aspherical.

TABLE 10

| | S2 | S3 | S4 | S5 | S7 | S8 | S9 |
|---|---|---|---|---|---|---|---|
| K | −1.120 | 74.925 | −4.773 | −0.604 | 19.009 | 10.604 | 3.803 |
| A | 2.298E−03 | −1.529E−02 | −1.525E−02 | −4.526E−03 | −1.301E−02 | −1.865E−02 | −2.564E−02 |
| B | −8.109E−04 | 1.576E−02 | 1.405E−02 | 1.657E−03 | 1.042E−02 | 1.794E−02 | 3.432E−02 |
| C | 1.374E−03 | −1.129E−02 | −1.114E−02 | −1.930E−03 | −1.408E−02 | −1.588E−02 | −2.591E−02 |
| D | −1.413E−03 | 6.286E−03 | 7.805E−03 | 3.328E−03 | 1.286E−02 | 8.799E−03 | 1.281E−02 |
| E | 9.688E−04 | −2.731E−03 | −4.616E−03 | −4.035E−03 | −8.561E−03 | −3.349E−03 | −4.815E−03 |
| F | −4.610E−04 | 9.243E−04 | 2.207E−03 | 3.500E−03 | 4.280E−03 | 9.270E−04 | 1.509E−03 |
| G | 1.562E−04 | −2.429E−04 | −8.241E−04 | −2.212E−03 | −1.619E−03 | −1.979E−04 | −4.027E−04 |
| H | −3.817E−05 | 4.923E−05 | 2.341E−04 | 1.025E−03 | 4.620E−04 | 3.503E−05 | 8.779E−05 |
| J | 6.744E−06 | −7.602E−06 | −4.958E−05 | −3.475E−04 | −9.827E−05 | −5.421E−06 | −1.474E−05 |
| L | −8.525E−07 | 8.757E−07 | 7.646E−06 | 8.479E−05 | 1.528E−05 | 7.202E−07 | 1.817E−06 |
| M | 7.513E−08 | −7.267E−08 | −8.306E−07 | −1.446E−05 | −1.682E−06 | −7.521E−08 | −1.569E−07 |
| N | −4.380E−09 | 4.094E−09 | 6.007E−08 | 1.633E−06 | 1.239E−07 | 5.514E−09 | 8.936E−09 |
| O | 1.517E−10 | −1.398E−10 | −2.591E−09 | −1.093E−07 | −5.478E−09 | −2.461E−10 | −3.009E−10 |
| P | −2.365E−12 | 2.180E−12 | 5.038E−11 | 3.280E−09 | 1.099E−10 | 4.976E−12 | 4.534E−12 |
| | S10 | S11 | S12 | S13 | S14 | S15 | S16 |
| K | −90.000 | 81.981 | 90.000 | −2.160 | −6.453 | −35.596 | −0.986 |
| A | −3.823E−02 | −4.487E−02 | −3.755E−02 | 2.609E−02 | 5.239E−02 | −2.374E−03 | −5.381E−02 |
| B | 4.162E−02 | 4.896E−02 | 2.318E−02 | −1.690E−02 | −2.304E−02 | −1.870E−02 | 9.294E−03 |
| C | −2.533E−02 | −2.773E−02 | −1.055E−02 | 6.071E−03 | 6.391E−03 | 1.008E−02 | −1.838E−03 |
| D | 9.704E−03 | 1.046E−02 | 3.596E−03 | −1.835E−03 | −1.422E−03 | −3.291E−03 | 3.925E−04 |
| E | −2.595E−03 | −2.884E−03 | −9.482E−04 | 4.299E−04 | 2.479E−04 | 7.275E−04 | −8.206E−05 |
| F | 5.003E−04 | 5.897E−04 | 1.887E−04 | −7.625E−05 | −3.270E−05 | −1.102E−04 | 1.413E−05 |
| G | −6.704E−05 | −8.836E−05 | −2.764E−05 | 1.010E−05 | 3.227E−06 | 1.161E−05 | −1.774E−06 |
| H | 5.089E−06 | 9.429E−06 | 2.965E−06 | −9.811E−07 | −2.387E−07 | −8.657E−07 | 1.563E−07 |
| J | 7.842E−08 | −6.765E−07 | −2.338E−07 | 6.868E−08 | 1.327E−08 | 4.596E−08 | −9.580E−09 |
| L | −7.317E−08 | 2.785E−08 | 1.360E−08 | −3.400E−09 | −5.509E−10 | −1.728E−09 | 4.063E−10 |
| M | 9.231E−09 | −1.817E−10 | −5.750E−10 | 1.156E−10 | 1.670E−11 | 4.503E−11 | −1.169E−11 |
| N | −6.064E−10 | −4.353E−11 | 1.688E−11 | −2.565E−12 | −3.502E−13 | −7.737E−13 | 2.178E−13 |
| O | 2.137E−11 | 2.093E−12 | −3.079E−13 | 3.338E−14 | 4.529E−15 | 7.891E−15 | −2.374E−15 |
| P | −3.192E−13 | −3.250E−14 | 2.610E−15 | −1.933E−16 | −2.707E−17 | −3.620E−17 | 1.149E−17 |

Also, the optical imaging system configured as described above may have the aberration properties illustrated in FIG. 10.

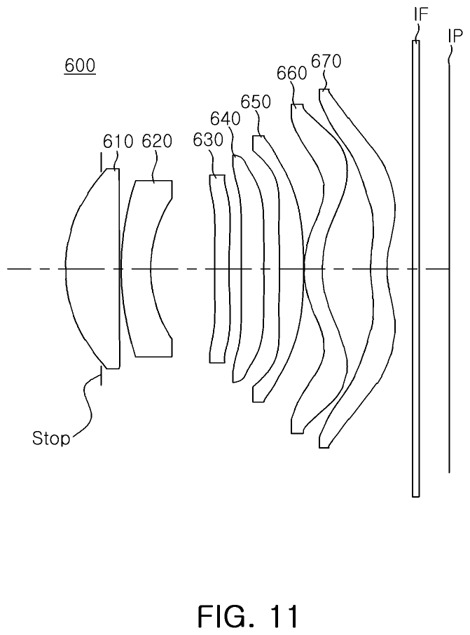

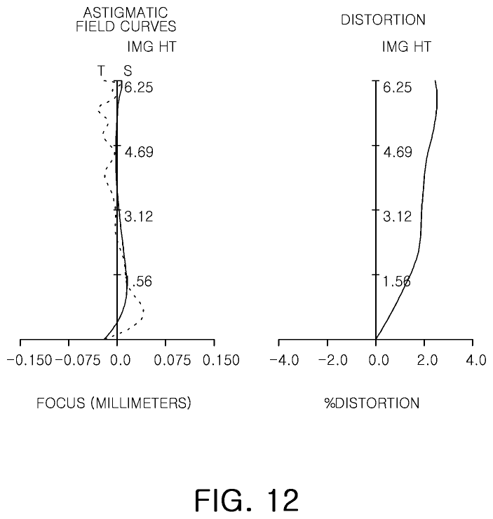

An optical imaging system 600 according to a sixth embodiment may be described with reference to FIGS. 11 and 12.

The optical imaging system 600 according to the sixth embodiment may include a first lens 610, a second lens 620, a third lens 630, a fourth lens 640, a fifth lens 650, a sixth lens 660, and a seventh lens 670, and may further include a filter IF and an image sensor.

A stop may be disposed on the front side of the first lens 610 and between the second lens 620 and the third lens 630.

The optical imaging system 600 according to the sixth embodiment may form a focus on an imaging plane IP.

The lens characteristics (a radius, a thickness of lens or a distance between lenses, a refractive index, and an Abbe number) of each lens may be as in Table 11.

TABLE 11

| Sur- | | | Thick- | Refrac- | | Effec- |
|---|---|---|---|---|---|---|
| face | | Radius of | ness or | tive | Abbe | tive |
| No. | Element | curvature | distance | index | number | radius |
| S1 | Stop | Infinity | −1.100 | | | 2.972 |
| S2 | First lens | 4.259 | 1.655 | 1.546 | 55.99 | 2.972 |
| S3 | | 72.555 | 0.050 | | | 2.836 |
| S4 | Second lens | 6.288 | 0.910 | 1.677 | 19.24 | 2.620 |
| S5 | | 3.634 | 1.197 | | | 2.146 |
| S6 | Stop | Infinity | 0.764 | | | 2.043 |
| S7 | Third lens | 20.470 | 0.444 | 1.667 | 20.38 | 2.553 |
| S8 | | 14.675 | 0.373 | | | 2.760 |
| S9 | Fourth lens | 48.570 | 0.694 | 1.546 | 55.99 | 3.124 |
| S10 | | 33.186 | 0.479 | | | 3.255 |
| S11 | Fifth lens | 100.323 | 0.741 | 1.570 | 37.40 | 3.630 |
| S12 | | −79.878 | 0.013 | | | 3.810 |
| S13 | Sixth lens | 3.023 | 0.560 | 1.546 | 55.99 | 4.693 |
| S14 | | 4.683 | 1.484 | | | 4.748 |
| S15 | Seventh lens | 4.008 | 0.500 | 1.537 | 55.74 | 5.170 |
| S16 | | 2.496 | 0.782 | | | 5.145 |
| S17 | Filter | Infinity | 0.210 | 1.518 | 64.17 | |
| S18 | | Infinity | 0.924 | | | |
| S19 | Imaging plane | Infinity | | | | |

In the sixth embodiment, the first lens 610 may have positive refractive power, an object-side surface of the first lens 610 may be convex in a paraxial region, and an image-side surface of the first lens 610 may be concave in a paraxial region.

The second lens 620 may have negative refractive power, an object-side surface of the second lens 620 may be convex in a paraxial region, and an image-side surface of the second lens 620 may be concave in a paraxial region.

The third lens 630 may have negative refractive power, an object-side surface of the third lens 630 may be convex in a paraxial region, and an image-side surface of the third lens 630 may be concave in a paraxial region.

The fourth lens 640 may have negative refractive power, and an object-side surface of the fourth lens 640 may be convex in a paraxial region, and an image-side surface of the fourth lens 640 may be concave in a paraxial region.

The fifth lens 650 may have positive refractive power, and an object-side surface and an image-side surface of the fifth lens 650 may be convex in a paraxial region.

The sixth lens 660 may have positive refractive power, an object-side surface of the sixth lens 660 may be convex in a paraxial region, and an image-side surface of the sixth lens 660 may be concave in a paraxial region.

The seventh lens 670 may have negative refractive power, an object-side surface of the seventh lens 670 may be convex in a paraxial region, and an image-side surface of the seventh lens 670 may be concave in a paraxial region.

Also, one or more of the sixth lens 660 and the seventh lens 670 may have at least one inflection point on at least one of an object-side surface and an image-side surface.

Each surface of the first lens 610 to the seventh lens 670 may have an aspherical coefficient as in Table 12. For example, object-side surfaces and image-side surfaces of the first lens 610 to the seventh lens 670 may be aspherical.

TABLE 12

| | S2 | S3 | S4 | S5 | S7 | S8 | S9 |
|---|---|---|---|---|---|---|---|
| K | −1.123 | 90.000 | −4.962 | −0.668 | 12.343 | 8.498 | −89.992 |
| A | 2.089E−03 | −1.902E−02 | −1.840E−02 | −6.454E−03 | −1.345E−02 | −1.847E−02 | −2.609E−02 |
| B | −8.976E−05 | 2.443E−02 | 2.106E−02 | 9.080E−03 | 1.264E−02 | 2.138E−02 | 3.786E−02 |
| C | 9.981E−05 | −2.225E−02 | −1.999E−02 | −2.227E−02 | −1.721E−02 | −2.217E−02 | −3.023E−02 |
| D | −5.890E−05 | 1.529E−02 | 1.515E−02 | 3.902E−02 | 1.506E−02 | 1.456E−02 | 1.529E−02 |
| E | 2.768E−05 | −7.838E−03 | −8.823E−03 | −4.610E−02 | −9.427E−03 | −6.778E−03 | −5.471E−03 |
| F | −1.110E−05 | 2.987E−03 | 3.907E−03 | 3.815E−02 | 4.465E−03 | 2.378E−03 | 1.471E−03 |
| G | 3.936E−06 | −8.467E−04 | −1.311E−03 | −2.267E−02 | −1.648E−03 | −6.549E−04 | −3.073E−04 |
| H | −1.149E−06 | 1.784E−04 | 3.316E−04 | 9.800E−03 | 4.759E−04 | 1.443E−04 | 5.010E−05 |
| J | 2.513E−07 | −2.776E−05 | −6.269E−05 | −3.085E−03 | −1.058E−04 | −2.518E−05 | −6.194E−06 |
| L | −3.884E−08 | 3.140E−06 | 8.698E−06 | 6.992E−04 | 1.754E−05 | 3.366E−06 | 5.471E−07 |
| M | 4.068E−09 | −2.507E−07 | −8.577E−07 | −1.111E−04 | −2.081E−06 | −3.283E−07 | −3.137E−08 |
| N | −2.738E−10 | 1.337E−08 | 5.681E−08 | 1.173E−05 | 1.657E−07 | 2.178E−08 | 9.571E−10 |
| O | 1.067E−11 | −4.272E−10 | −2.262E−09 | −7.391E−07 | −7.910E−09 | −8.745E−10 | −5.309E−12 |
| P | −1.830E−13 | 6.172E−12 | 4.087E−11 | 2.100E−08 | 1.705E−10 | 1.598E−11 | −3.193E−13 |
| | S10 | S11 | S12 | S13 | S14 | S15 | S16 |
| K | −90.000 | 90.000 | −88.856 | −2.155 | −6.016 | −24.231 | −0.994 |
| A | −4.282E−02 | −5.159E−02 | −4.017E−02 | 3.025E−02 | 5.854E−02 | −1.562E−02 | −6.376E−02 |
| B | 4.752E−02 | 6.119E−02 | 2.634E−02 | −2.227E−02 | −2.854E−02 | −9.450E−03 | 1.386E−02 |
| C | −2.857E−02 | −3.759E−02 | −1.359E−02 | 8.600E−03 | 8.664E−03 | 6.100E−03 | −3.062E−03 |
| D | 1.017E−02 | 1.550E−02 | 5.514E−03 | −2.621E−03 | −2.042E−03 | −2.058E−03 | 6.080E−04 |
| E | −2.150E−03 | −4.685E−03 | −1.761E−03 | 6.078E−04 | 3.742E−04 | 4.683E−04 | −1.017E−04 |
| F | 1.720E−04 | 1.060E−03 | 4.285E−04 | −1.062E−04 | −5.253E−05 | −7.353E−05 | 1.380E−05 |
| G | 4.810E−05 | −1.786E−04 | −7.764E−05 | 1.387E−05 | 5.602E−06 | 8.073E−06 | −1.449E−06 |
| H | −2.064E−05 | 2.216E−05 | 1.039E−05 | −1.338E−06 | −4.513E−07 | −6.280E−07 | 1.133E−07 |
| J | 4.013E−06 | −1.978E−06 | −1.019E−06 | 9.376E−08 | 2.724E−08 | 3.485E−08 | −6.422E−09 |
| L | −4.916E−07 | 1.227E−07 | 7.219E−08 | −4.681E−09 | −1.211E−09 | −1.372E−09 | 2.579E−10 |
| M | 3.972E−08 | −4.955E−09 | −3.593E−09 | 1.616E−10 | 3.845E−11 | 3.748E−11 | −7.131E−12 |
| N | −2.059E−09 | 1.133E−10 | 1.188E−10 | −3.655E−12 | −8.231E−13 | −6.762E−13 | 1.290E−13 |
| O | 6.212E−11 | −9.165E−13 | −2.340E−12 | 4.870E−14 | 1.062E−14 | 7.249E−15 | −1.374E−15 |
| P | −8.302E−13 | −7.094E−15 | 2.072E−14 | −2.895E−16 | −6.221E−17 | −3.498E−17 | 6.533E−18 |

Also, the optical imaging system configured as described above may have the aberration properties illustrated in FIG. 12.

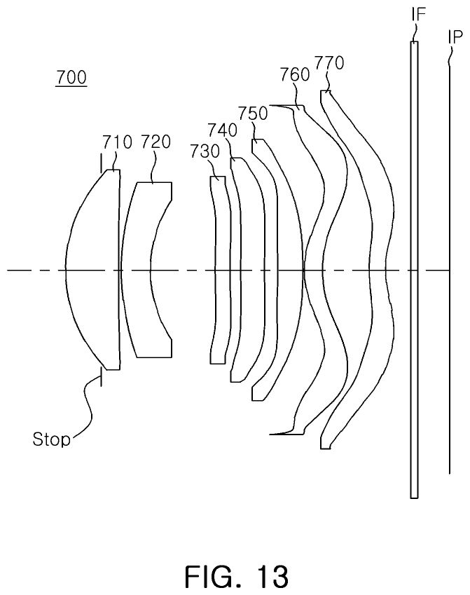

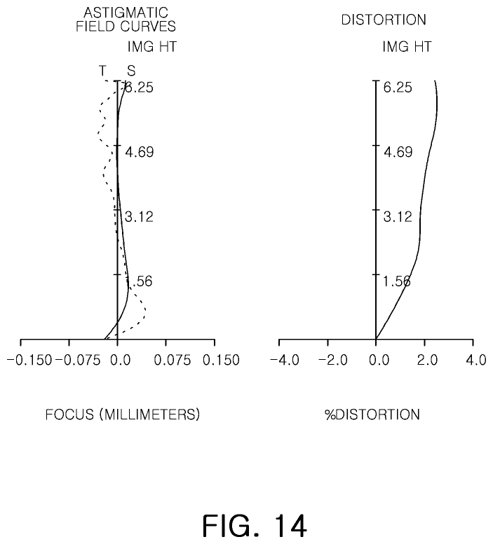

An optical imaging system 700 according to a seventh embodiment may be described with reference to FIGS. 13 and 14.

The optical imaging system 700 according to the seventh embodiment may include a first lens 710, a second lens 720, a third lens 730, a fourth lens 740, a fifth lens 750, a sixth lens 760, and a seventh lens 770, and may further include a filter IF and an image sensor.

A stop may be disposed on the front side of the first lens 710 and between the second lens 720 and the third lens 730.

The optical imaging system 700 according to the seventh embodiment may form a focus on an imaging plane IP.

The lens characteristics (a radius, a thickness of lens or a distance between lenses, a refractive index, and an Abbe number) of each lens may be as in Table 13.

TABLE 13

| Sur- | | | Thick- | Refrac- | | Effec- |
|---|---|---|---|---|---|---|
| face | | Radius of | ness or | tive | Abbe | tive |
| No. | Element | curvature | distance | index | number | radius |
| S1 | Stop | Infinity | −1.100 | | | |
| S2 | First lens | 4.260 | 1.640 | 1.546 | 55.99 | 2.971 |
| S3 | | 61.751 | 0.066 | | | 2.841 |
| S4 | Second lens | 5.853 | 0.895 | 1.693 | 18.33 | 2.622 |
| S5 | | 3.536 | 1.224 | | | 2.166 |
| S6 | Stop | Infinity | 0.774 | | | 2.027 |
| S7 | Third lens | 21.755 | 0.448 | 1.667 | 20.38 | 2.550 |
| S8 | | 14.943 | 0.334 | | | 2.773 |
| S9 | Fourth lens | 57.822 | 0.726 | 1.546 | 55.99 | 3.019 |
| S10 | | 24.965 | 0.398 | | | 3.197 |
| S11 | Fifth lens | 98.099 | 0.774 | 1.570 | 37.40 | 3.426 |
| S12 | | −39.215 | 0.050 | | | 3.713 |
| S13 | Sixth lens | 3.023 | 0.560 | 1.546 | 55.99 | 4.407 |
| S14 | | 4.602 | 1.425 | | | 4.740 |
| S15 | Seventh lens | 3.822 | 0.500 | 1.537 | 55.74 | 4.945 |
| S16 | | 2.464 | 0.782 | | | 5.141 |
| S17 | Filter | Infinity | 0.210 | 1.518 | 64.17 | |
| S18 | | Infinity | 0.975 | | | |
| S19 | Imaging plane | Infinity | | | | |

In the seventh embodiment, the first lens 710 may have positive refractive power, an object-side surface of the first lens 710 may be convex in a paraxial region, and an image-side surface of the first lens 710 may be concave in a paraxial region.

The second lens 720 may have negative refractive power, an object-side surface of the second lens 720 may be convex in a paraxial region, and an image-side surface of the second lens 720 may be concave in a paraxial region.

The third lens 730 may have negative refractive power, an object-side surface of the third lens 730 may be convex in a paraxial region, and an image-side surface of the third lens 730 may be concave in a paraxial region.

The fourth lens 740 may have negative refractive power, an object-side surface of the fourth lens 740 may be convex in a paraxial region, and an image-side surface of the fourth lens 740 may be concave in a paraxial region.

The fifth lens 750 may have positive refractive power, and an object-side surface and an image-side surface of the fifth lens 750 may be convex in a paraxial region.

The sixth lens 760 may have positive refractive power, an object-side surface of the sixth lens 760 may be convex in a paraxial region, and an image-side surface of the sixth lens 760 may be concave in a paraxial region.

The seventh lens 770 may have negative refractive power, an object-side surface of the seventh lens 770 may be convex in a paraxial region, and an image-side surface of the seventh lens 770 may be concave in a paraxial region.

Also, one or more of the sixth lens 760 and the seventh lens 770 may have at least one inflection point on at least one of an object-side surface and an image-side surface.

Each surface of the first lens 710 to the seventh lens 770 may have an aspherical coefficient as in Table 14. For example, object-side surfaces and image-side surfaces of the first lens 710 to the seventh lens 770 may be aspherical.

TABLE 14

| | S2 | S3 | S4 | S5 | S7 | S8 | S9 |
|---|---|---|---|---|---|---|---|
| K | −1.122 | 70.642 | −4.494 | −0.704 | 11.947 | 7.470 | −90.000 |
| A | 1.856E−03 | −1.650E−02 | −1.588E−02 | −7.133E−03 | −1.263E−02 | −1.719E−02 | −2.489E−02 |
| B | 4.424E−04 | 1.929E−02 | 1.649E−02 | 1.094E−02 | 1.067E−02 | 1.746E−02 | 3.552E−02 |
| C | −6.958E−04 | −1.625E−02 | −1.465E−02 | −2.659E−02 | −1.494E−02 | −1.527E−02 | −2.674E−02 |
| D | 7.036E−04 | 1.053E−02 | 1.086E−02 | 4.648E−02 | 1.354E−02 | 6.792E−03 | 1.149E−02 |
| E | −4.622E−04 | −5.152E−03 | −6.402E−03 | −5.544E−02 | −8.862E−03 | −8.763E−04 | −2.811E−03 |
| F | 2.077E−04 | 1.884E−03 | 2.927E−03 | 4.652E−02 | 4.403E−03 | −7.761E−04 | 2.195E−04 |
| G | −6.564E−05 | −5.129E−04 | −1.024E−03 | −2.806E−02 | −1.689E−03 | 5.627E−04 | 1.067E−04 |
| H | 1.482E−05 | 1.035E−04 | 2.713E−04 | 1.230E−02 | 4.977E−04 | −1.999E−04 | −4.894E−05 |
| J | −2.401E−06 | −1.537E−05 | −5.369E−05 | −3.915E−03 | −1.104E−04 | 4.608E−05 | 1.112E−05 |
| L | 2.768E−07 | 1.647E−06 | 7.775E−06 | 8.956E−04 | 1.790E−05 | −7.308E−06 | −1.650E−06 |
| M | −2.215E−08 | −1.235E−07 | −7.976E−07 | −1.433E−04 | −2.042E−06 | 7.961E−07 | 1.656E−07 |
| N | 1.170E−09 | 6.115E−09 | 5.474E−08 | 1.520E−05 | 1.542E−07 | −5.706E−08 | −1.086E−08 |
| O | −3.666E−11 | −1.785E−10 | −2.250E−09 | −9.607E−07 | −6.903E−09 | 2.424E−09 | 4.190E−10 |
| P | 5.161E−13 | 2.306E−12 | 4.182E−11 | 2.734E−08 | 1.382E−10 | −4.620E−11 | −7.207E−12 |
| | S10 | S11 | S12 | S13 | S14 | S15 | S16 |
| K | −58.885 | 90.000 | −90.000 | −2.136 | −6.079 | −21.333 | −0.997 |
| A | −4.629E−02 | −5.497E−02 | −4.239E−02 | 2.665E−02 | 5.926E−02 | −1.216E−02 | −6.150E−02 |
| B | 5.236E−02 | 6.349E−02 | 2.710E−02 | −1.902E−02 | −3.021E−02 | −1.071E−02 | 1.257E−02 |
| C | −3.087E−02 | −3.704E−02 | −1.284E−02 | 6.982E−03 | 1.006E−02 | 6.288E−03 | −2.731E−03 |
| D | 1.073E−02 | 1.430E−02 | 4.692E−03 | −2.015E−03 | −2.653E−03 | −2.033E−03 | 5.703E−04 |
| E | −2.300E−03 | −4.034E−03 | −1.356E−03 | 4.293E−04 | 5.365E−04 | 4.511E−04 | −1.041E−04 |
| F | 2.602E−04 | 8.506E−04 | 2.991E−04 | −6.749E−05 | −8.113E−05 | −6.980E−05 | 1.539E−05 |
| G | 6.418E−06 | −1.330E−04 | −4.853E−05 | 7.945E−06 | 9.110E−06 | 7.586E−06 | −1.732E−06 |
| H | −8.411E−06 | 1.505E−05 | 5.688E−06 | −7.011E−07 | −7.587E−07 | −5.849E−07 | 1.426E−07 |
| J | 1.683E−06 | −1.181E−06 | −4.768E−07 | 4.583E−08 | 4.666E−08 | 3.215E−08 | −8.416E−09 |
| L | −1.944E−07 | 5.902E−08 | 2.817E−08 | −2.170E−09 | −2.090E−09 | −1.251E−09 | 3.497E−10 |
| M | 1.437E−08 | −1.444E−09 | −1.140E−09 | 7.194E−11 | 6.624E−11 | 3.372E−11 | −9.971E−12 |
| N | −6.684E−10 | −1.293E−11 | 2.988E−11 | −1.578E−12 | −1.408E−12 | −5.984E−13 | 1.855E−13 |
| O | 1.774E−11 | 1.731E−12 | −4.505E−13 | 2.052E−14 | 1.797E−14 | 6.293E−15 | −2.027E−15 |
| P | −2.032E−13 | −3.154E−14 | 2.895E−15 | −1.197E−16 | −1.040E−16 | −2.972E−17 | 9.875E−18 |

Also, the optical imaging system configured as described above may have the aberration properties illustrated in FIG. 14.

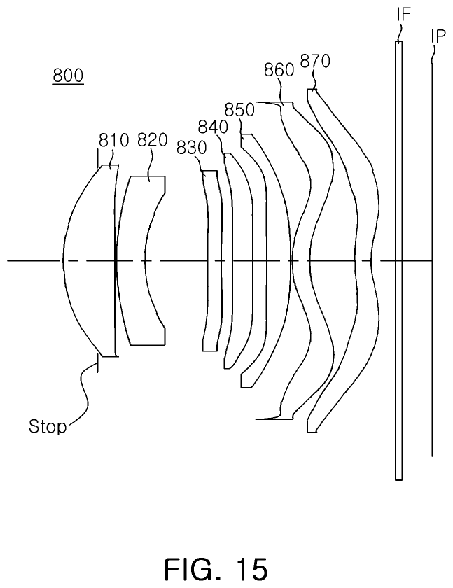

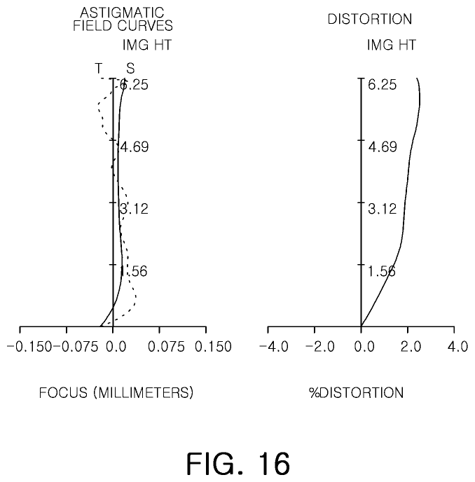

An optical imaging system 800 according to an eighth embodiment may be described with reference to FIGS. 15 and 16.

The optical imaging system 800 according to the eighth embodiment may include a first lens 810, a second lens 820, a third lens 830, a fourth lens 840, a fifth lens 850, a sixth lens 860, and a seventh lens 870, and may further include a filter IF and an image sensor.

A stop may be disposed on the front side of the first lens 810 and between the second lens 820 and the third lens 830.

The optical imaging system 800 according to the eighth embodiment may form a focus on an imaging plane IP.

The lens characteristics (a radius, a thickness of lens or a distance between lenses, a refractive index, and an Abbe number) of each lens may be as in Table 15.

TABLE 15

| Sur- | | | Thick- | Refrac- | | Effec- |
|---|---|---|---|---|---|---|
| face | | Radius of | ness or | tive | Abbe | tive |
| No. | Element | curvature | distance | index | number | radius |
| S1 | Stop | Infinity | −1.100 | | | 2.971 |
| S2 | First lens | 4.272 | 1.645 | 1.546 | 55.99 | 2.971 |
| S3 | | 74.015 | 0.050 | | | 2.835 |
| S4 | Second lens | 6.225 | 0.903 | 1.677 | 19.24 | 2.615 |
| S5 | | 3.623 | 1.223 | | | 2.147 |
| S6 | Stop | Infinity | 0.784 | | | 2.012 |
| S7 | Third lens | 19.876 | 0.433 | 1.667 | 20.38 | 2.542 |
| S8 | | 14.261 | 0.354 | | | 2.757 |
| S9 | Fourth lens | 39.111 | 0.651 | 1.546 | 55.99 | 3.120 |
| S10 | | 26.042 | 0.454 | | | 3.238 |
| S11 | Fifth lens | 100.531 | 0.754 | 1.570 | 37.40 | 3.631 |
| S12 | | −58.529 | 0.050 | | | 3.777 |
| S13 | Sixth lens | 3.105 | 0.572 | 1.546 | 55.99 | 4.746 |
| S14 | | 4.831 | 1.430 | | | 4.759 |
| S15 | Seventh lens | 3.896 | 0.518 | 1.537 | 55.74 | 5.159 |
| S16 | | 2.468 | 0.782 | | | 5.142 |
| S17 | Filter | Infinity | 0.210 | 1.518 | 64.17 | |
| S18 | | Infinity | 0.968 | | | |
| S19 | Imaging plane | Infinity | | | | |

In the eighth embodiment, the eighth lens 810 may have positive refractive power, an object-side surface of the first lens 810 may be convex in a paraxial region, and an image-side surface of the first lens 810 may be concave in a paraxial region.

The second lens 820 may have negative refractive power, an object-side surface of the second lens 820 may be convex in a paraxial region, and an image-side surface of the second lens 820 may be concave in a paraxial region.

The third lens 830 may have negative refractive power, an object-side surface of the third lens 830 may be convex in a paraxial region, and an image-side surface of the third lens 830 may be concave in a paraxial region.

The fourth lens 840 may have negative refractive power, an object-side surface of the fourth lens 840 may be convex in a paraxial region, and an image-side surface of the fourth lens 840 may be concave in a paraxial region.

The fifth lens 850 may have positive refractive power, and an object-side surface and an image-side surface of the fifth lens 850 may be convex in a paraxial region.

The sixth lens 860 may have positive refractive power, an object-side surface of the sixth lens 860 may be convex in a paraxial region, and an image-side surface of the sixth lens 860 may be concave in a paraxial region.

The seventh lens 870 may have negative refractive power, an object-side surface of the seventh lens 870 may be convex in a paraxial region, and an image-side surface of the seventh lens 870 may be concave in a paraxial region.

Also, one or more of the sixth lens 860 and the seventh lens 870 may have at least one inflection point on at least one of an object-side surface and an image-side surface.

Each surface of the first lens 810 to the seventh lens 870 may have an aspherical coefficient as in Table 16. For example, object-side surfaces and image-side surfaces of the first lens 810 to the seventh lens 870 may be aspherical.

TABLE 16

| | S2 | S3 | S4 | S5 | S7 | S8 | S9 |
|---|---|---|---|---|---|---|---|
| K | −1.138 | 81.056 | −4.916 | −0.698 | 9.171 | 8.340 | −58.151 |
| A | 1.011E−03 | −2.032E−02 | −1.871E−02 | −7.200E−03 | −1.305E−02 | −1.788E−02 | −2.675E−02 |
| B | 3.029E−03 | 2.852E−02 | 2.148E−02 | 1.253E−02 | 1.115E−02 | 1.861E−02 | 3.744E−02 |
| C | −4.794E−03 | −2.892E−02 | −1.945E−02 | −3.237E−02 | −1.461E−02 | −1.698E−02 | −2.796E−02 |
| D | 4.650E−03 | 2.222E−02 | 1.329E−02 | 5.819E−02 | 1.226E−02 | 8.990E−03 | 1.248E−02 |
| E | −2.965E−03 | −1.273E−02 | −6.568E−03 | −7.062E−02 | −7.309E−03 | −2.793E−03 | −3.583E−03 |
| F | 1.305E−03 | 5.415E−03 | 2.280E−03 | 5.991E−02 | 3.287E−03 | 3.712E−04 | 6.573E−04 |
| G | −4.079E−04 | −1.712E−03 | −5.282E−04 | −3.634E−02 | −1.158E−03 | 7.467E−05 | −6.699E−05 |
| H | 9.194E−05 | 4.016E−04 | 6.999E−05 | 1.595E−02 | 3.227E−04 | −4.963E−05 | −1.172E−07 |
| J | −1.498E−05 | −6.953E−05 | −8.990E−07 | −5.070E−03 | −6.990E−05 | 1.252E−05 | 1.312E−06 |
| L | 1.750E−06 | 8.748E−06 | −1.580E−06 | 1.155E−03 | 1.136E−05 | −1.934E−06 | −2.495E−07 |
| M | −1.427E−07 | −7.766E−07 | 3.202E−07 | −1.836E−04 | −1.319E−06 | 1.962E−07 | 2.709E−08 |
| N | 7.716E−09 | 4.607E−08 | −3.172E−08 | 1.934E−05 | 1.023E−07 | −1.284E−08 | −1.851E−09 |
| O | −2.486E−10 | −1.638E−09 | 1.665E−09 | −1.211E−06 | −4.721E−09 | 4.940E−10 | 7.359E−11 |
| P | 3.612E−12 | 2.637E−11 | −3.705E−11 | 3.414E−08 | 9.763E−11 | −8.496E−12 | −1.294E−12 |
| | S10 | S11 | S12 | S13 | S14 | S15 | S16 |
| K | −81.686 | −90.000 | −68.559 | −2.115 | −5.936 | −21.790 | −0.999 |
| A | −4.502E−02 | −5.071E−02 | −4.050E−02 | 2.760E−02 | 5.709E−02 | −1.583E−02 | −6.363E−02 |
| B | 5.227E−02 | 5.767E−02 | 2.486E−02 | −1.989E−02 | −2.770E−02 | −7.869E−03 | 1.434E−02 |
| C | −3.296E−02 | −3.322E−02 | −1.162E−02 | 7.530E−03 | 8.514E−03 | 4.928E−03 | −3.453E−03 |
| D | 1.304E−02 | 1.261E−02 | 4.302E−03 | −2.295E−03 | −2.060E−03 | −1.609E−03 | 7.473E−04 |
| E | −3.611E−03 | −3.470E−03 | −1.301E−03 | 5.323E−04 | 3.882E−04 | 3.624E−04 | −1.309E−04 |
| F | 7.454E−04 | 7.101E−04 | 3.101E−04 | −9.274E−05 | −5.566E−05 | −5.697E−05 | 1.779E−05 |
| G | −1.200E−04 | −1.071E−04 | −5.623E−05 | 1.207E−05 | 6.011E−06 | 6.286E−06 | −1.827E−06 |
| H | 1.553E−05 | 1.153E−05 | 7.613E−06 | −1.160E−06 | −4.865E−07 | −4.920E−07 | 1.387E−07 |
| J | −1.639E−06 | −8.314E−07 | −7.613E−07 | 8.103E−08 | 2.929E−08 | 2.747E−08 | −7.647E−09 |
| L | 1.404E−07 | 3.348E−08 | 5.530E−08 | −4.035E−09 | −1.292E−09 | −1.088E−09 | 3.004E−10 |
| M | −9.475E−09 | −7.828E−11 | −2.829E−09 | 1.389E−10 | 4.050E−11 | 2.992E−11 | −8.170E−12 |
| N | 4.696E−10 | −6.444E−11 | 9.627E−11 | −3.135E−12 | −8.537E−13 | −5.429E−13 | 1.460E−13 |
| O | −1.492E−11 | 2.964E−12 | −1.950E−12 | 4.167E−14 | 1.083E−14 | 5.851E−15 | −1.542E−15 |
| P | 2.227E−13 | −4.554E−14 | 1.774E−14 | −2.471E−16 | −6.230E−17 | −2.838E−17 | 7.290E−18 |

Also, the optical imaging system configured as above may have the aberration properties illustrated in FIG. 16.

TABLE 17

| Property | Emb. 1 | Emb. 2 | Emb. 3 | Emb. 4 |
|---|---|---|---|---|
| f | 10.099 | 10.099 | 10.099 | 10.099 |
| f1 | 8.268 | 8.222 | 8.208 | 9.413 |
| f2 | −15.181 | −14.696 | −15.999 | −25.179 |
| f3 | −72.071 | −78.591 | −58.019 | −48.146 |
| f4 | −124.482 | −159.390 | −307.244 | 35.440 |
| f5 | 52.809 | 70.882 | 34.245 | 327.145 |
| f6 | 14.802 | 14.025 | 17.335 | 12.082 |
| f7 | −15.076 | −14.376 | −12.112 | −7.333 |
| f12 | 13.133 | 13.192 | 12.603 | 13.084 |
| f34567 | 73.448 | 77.919 | 1473.519 | −75.941 |
| 2 × IMG HT | 12.494 | 12.494 | 12.494 | 12.494 |
| Fno | 1.70 | 1.70 | 1.70 | 1.69 |
| FOV | 62.22 | 62.18 | 62.18 | 62.44 |

| Property | Emb. 5 | Emb. 6 | Emb. 7 | Emb. 8 |
|---|---|---|---|---|
| f | 10.099 | 10.099 | 10.099 | 10.099 |
| f1 | 8.259 | 8.220 | 8.301 | 8.237 |
| f2 | −14.869 | −14.757 | −15.304 | −14.887 |
| f3 | −77.320 | −80.223 | −73.539 | −78.140 |
| f4 | −322.514 | −195.081 | −81.131 | −145.347 |
| f5 | 83.278 | 78.149 | 49.260 | 65.022 |
| f6 | 14.205 | 13.961 | 14.344 | 14.260 |
| f7 | −14.021 | −13.941 | −14.830 | −14.363 |
| f12 | 13.170 | 13.163 | 12.970 | 13.152 |
| f34567 | 90.739 | 87.364 | 83.317 | 82.533 |
| 2 × IMG HT | 12.494 | 12.494 | 12.494 | 12.494 |
| Fno | 1.70 | 1.70 | 1.70 | 1.70 |
| FOV | 62.17 | 62.17 | 62.19 | 62.21 |

In Table 17, f may be the total focal length of the optical imaging system (total focal length of the first lens to the seventh lens), f1 may be the focal length of the first lens, f2 may be the focal length of the second lens, f3 may be the focal length of the third lens, f4 may be the focal length of the fourth lens, f5 may be the focal length of the fifth lens, f6 may be the focal length of the sixth lens, f7 may be the focal length of the seventh lens, f12 may be the combined focal length of the first lens and the second lens, f34567 may be the combined focal length of the third lens to the seventh lens, Fno may be the F-number of the optical imaging system, IMG HT may be half the diagonal length of the imaging plane, and FOV may be the field of view of the optical imaging system.

TABLE 18

| Conditional | | | | | | | | |
|---|---|---|---|---|---|---|---|---|
| Expression | Emb. 1 | Emb. 2 | Emb. 3 | Emb. 4 | Emb. 5 | Emb. 6 | Emb. 7 | Emb. 8 |
| (TTL/(2 × IMG | 1.603 | 1.603 | 1.603 | 1.594 | 1.603 | 1.603 | 1.603 | 1.603 |
| HT)) × Fno | | | | | | | | |
| FOV/(2 × IMG HT) | 4.980 | 4.977 | 4.977 | 4.998 | 4.976 | 4.976 | 4.978 | 4.979 |
| 1.2 × f/(2 × IMG HT) | 0.970 | 0.970 | 0.970 | 0.970 | 0.970 | 0.970 | 0.970 | 0.970 |
| T13/TTL | 0.391 | 0.389 | 0.354 | 0.265 | 0.381 | 0.388 | 0.390 | 0.391 |
| SD1/SD5 | 1.165 | 1.168 | 1.231 | 1.265 | 1.156 | 1.164 | 1.165 | 1.169 |
| SD6/SD14 | 0.539 | 0.535 | 0.514 | 0.510 | 0.543 | 0.536 | 0.539 | 0.536 |
| FOV/f | 6.161 | 6.157 | 6.157 | 6.183 | 6.156 | 6.156 | 6.158 | 6.160 |
| v1 − v2 | 36.750 | 36.750 | 36.750 | 36.750 | 36.750 | 36.750 | 37.660 | 36.750 |
| v1 − v5 | 18.590 | 18.590 | 18.590 | 18.590 | 18.590 | 18.590 | 18.590 | 18.590 |
| v1 − v7 | 0.250 | 0.250 | 0.250 | 0.250 | 0.250 | 0.250 | 0.250 | 0.250 |
| f1/f | 0.819 | 0.814 | 0.813 | 0.932 | 0.818 | 0.814 | 0.822 | 0.816 |
| f1/f12 | 0.630 | 0.623 | 0.651 | 0.719 | 0.627 | 0.624 | 0.640 | 0.626 |
| f12/\|f34567\| | 0.179 | 0.169 | 0.009 | 0.172 | 0.145 | 0.151 | 0.156 | 0.159 |
| TTL/(2 × IMG HT) | 0.943 | 0.943 | 0.943 | 0.943 | 0.943 | 0.943 | 0.943 | 0.943 |

The values listed in Tables 17 and 18 may be obtained by rounding to the third decimal place.

According to the aforementioned embodiments, an optical imaging system may implement high resolution.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens having positive refractive power;
a second lens having negative refractive power;
a third lens having refractive power;
a fourth lens having refractive power;
a fifth lens having refractive power;
a sixth lens having positive refractive power; and
a seventh lens having negative refractive power,
disposed in order from an object side,
wherein 0.9<1.2×f/(2×IMG HT)<1.1 is satisfied, where f is a total focal length of the first lens to the seventh lens, and IMG HT is half a diagonal length of an imaging plane.

2. The optical imaging system of claim 1, wherein 3 [°/mm]<FOV/(2×IMG HT)<6 [°/mm] is satisfied, where FOV is a field of view of the optical imaging system including the first lens to the seventh lens.

3. The optical imaging system of claim 1, wherein 4 [°/mm]<FOV/f<6.5 [°/mm] is satisfied, where FOV is a field of view of the optical imaging system including the first lens to the seventh lens.

4. The optical imaging system of claim 1, wherein 0.25<T13/TTL<0.4 is satisfied, where T13 is a distance on an optical axis from an object-side surface of the first lens to an object-side surface of the third lens, and TTL is a distance on the optical axis from an object-side surface of the first lens to the imaging plane.

5. The optical imaging system of claim 1, wherein 1.0<SD1/SD5<1.5 is satisfied, where SD1 is an effective radius of an object-side surface of the first lens, and SD5 is an effective radius of an object-side surface of the third lens.

6. The optical imaging system of claim 1, wherein 0.4<SD6/SD14<0.7 is satisfied, where SD6 is an effective radius of an image-side surface of the third lens, and SD14 is an effective radius of an image-side surface of the seventh lens.

7. The optical imaging system of claim 1,
wherein the second lens has a refractive index greater than 1.65, and
wherein 30<v1−v2<40 is satisfied, where v1 is an Abbe number of the first lens and v2 is an Abbe number of the second lens.

8. The optical imaging system of claim 1,
wherein each of the first lens and the fifth lens has a refractive index less than 1.6, and the refractive index of the first lens is less than the refractive index of the fifth lens, and
wherein 10<v1−v5<20 is satisfied, where v1 is an Abbe number of the first lens and v5 is an Abbe number of the fifth lens.

9. The optical imaging system of claim 1,
wherein each of the first lens and the seventh lens has a refractive index less than 1.6, and the refractive index of the seventh lens is less than the refractive index of the first lens, and
wherein 0<v1−v7<1 is satisfied, where v1 is an Abbe number of the first lens, and v7 is an Abbe number of the seventh lens.

10. The optical imaging system of claim 1, wherein (TTL/(2×IMG HT))×Fno<1.65 is satisfied, where TTL is a distance on the optical axis from an object-side surface of the first lens to the imaging plane, and Fno is an F-number of the optical imaging system including the first lens to the seventh lens.

11. The optical imaging system of claim 10, wherein 0.85<TTL/(2×IMG HT))<1.00 is satisfied.

12. The optical imaging system of claim 1, wherein 0.7<f1/f<1.1 is satisfied, where f1 is a focal length of the first lens.

13. The optical imaging system of claim 1, wherein 0.5<f1/f12<0.9 is satisfied, where f1 is a focal length of the first lens, and f12 is a combined focal length of the first lens and the second lens.

14. The optical imaging system of claim 1, wherein 0<f12/|f34567|<0.2 is satisfied, where f12 is a combined focal length of the first lens and the second lens, and f34567 is a combined focal length of the third lens to the seventh lens.

15. The optical imaging system of claim 1,
wherein the third lens has negative refractive power, and
wherein each of the second and third lenses has a refractive index greater than 1.65.

16. The optical imaging system of claim 1,
wherein the first lens has a convex object-side surface and a concave image-side surface,
wherein the second lens has a convex object-side surface and a concave image-side surface, and
wherein the fifth lens has a convex object-side surface and a concave image-side surface.
